(19) United States
(12) Patent Application Publication
(10) Pub. No.: US 2021/0078598 A1
(43) Pub. Date: Mar. 18, 2021

(54) AUTONOMOUS VEHICLE AND PEDESTRIAN GUIDANCE SYSTEM AND METHOD USING THE SAME

(71) Applicant: LG Electronics Inc., Seoul (KR)

(72) Inventor: Soryoung KIM, Seoul (KR)

(21) Appl. No.: 16/484,746

(22) PCT Filed: May 9, 2019
(86) PCT No.: PCT/KR2019/095006

§ 371 Date: Aug. 8, 2019

(51) Int. Cl. B60W 60/00; G08G 1/01; G06K 9/00; G05D 1/02

(52) U.S. Cl. CPC B60W 60/0017; G08G 1/0125; G08G 1/0141; G06K 9/00805; G06K 9/00362; B60W 2554/4044; G05D 1/0231; G05D 1/0276; B60W 2554/4029; B60W 2420/42; B60W 2556/65; G05D 1/0214

(57) ABSTRACT

Disclosed are an autonomous vehicle and a pedestrian guidance system and method using the same. The pedestrian guidance system according to an embodiment of the present invention includes at least one autonomous vehicle for transmitting pedestrian information recognizing a pedestrian and indicating the pedestrian based on a signal received from the pedestrian terminal to other vehicle. At least one of an autonomous vehicle, a user terminal, and a server of the present invention may be connected to or fused with an Artificial Intelligence (AI) module, a drone (Unmanned Aerial Vehicle (UAV)), a robot, an augmented reality (AR) device, a virtual reality (VR) device, and a device related to a 5G service.

### TECHNICAL FIELD

The present invention relates to an autonomous vehicle, and more particularly, to a pedestrian guidance system and method for recognizing a pedestrian who crosses a road by predicting a pedestrian's status and behavior.

### BACKGROUND ART

Autonomous vehicles are capable of driving themselves without a driver's intervention. Many companies have already entered an autonomous vehicle project and engaged in research and development.

Autonomous vehicles can support an automatic parking service that finds and parks an empty space without a driver's intervention.

### DISCLOSURE

### Technical Problem

Autonomous vehicles may recognize a pedestrian around the vehicle to avoid from colliding with the pedestrian. Such pedestrian recognition technology has been applied to autonomous vehicles, but there is still collision danger with pedestrians around the vehicle.

In the case of a multi-lane road, in some lanes, blind spots may exist in which pedestrians are not viewed, and a pedestrian is not viewed due to another vehicle or object. For this reason, it is difficult that the vehicle predicts collision danger with a pedestrian and brakes before an accident.

Because pedestrians cannot view vehicles in all lanes, the pedestrians are easily exposed to an unexpected accident. According to the pedestrian's status, a walking speed may be different. However, autonomous vehicle technology does not predict a time in which a pedestrian crosses a road in consideration of the pedestrian's status. For example, a time in which the walking vulnerable such as infants, pregnant women, the disabled, and the elderly cross a crosswalk is longer than that of young adults, but an existing signal system uniformly applies a signal conversion time instead of reflecting such pedestrians' status. In a process of crossing a road, pedestrians rely on only traffic lights for safety thereof.

An object of the present invention is to solve the above-described needs and/or problems.

The object of the present invention is not limited to the above-described objects and the other objects will be understood by those skilled in the art from the following description.

### Technical Solution

An autonomous vehicle according to at least an embodiment of the present invention for achieving the above object includes a camera for photographing a pedestrian; a controller for recognizing a pedestrian location based on a signal received from a pedestrian terminal carried by the pedestrian and analyzing an image taken by the camera to determine a type of the pedestrian, and transmitting pedestrian information including the type of the pedestrian to other vehicle through a communication device; and a brake drive unit for decelerating a driving speed after recognition of the pedestrian under the control of the controller.

A pedestrian guidance system according to at least one embodiment of the present invention includes a pedestrian terminal; and at least one autonomous vehicle for transmitting pedestrian information recognizing a pedestrian and indicating the pedestrian based on a signal received from the pedestrian terminal to other vehicle. The pedestrian information includes pedestrian type information obtained based on a pedestrian image taken by a camera. The pedestrian information is generated in a server for communicating with the vehicle through a controller of the vehicle or a network.

A method of guiding a pedestrian according to at least one embodiment of the present invention includes recognizing a pedestrian based on a signal received from a pedestrian terminal; and transmitting pedestrian information indicating the pedestrian to other vehicle. The pedestrian information includes pedestrian type information obtained based on a pedestrian image taken by the camera. The pedestrian information is generated in a server for communicating with the vehicle through a network or a controller of the vehicle.

### Advantageous Effects

According to the present invention, by enabling a vehicle that cannot view a pedestrian to recognize the pedestrian using communication between vehicles, vehicles driving on a road share pedestrian information without a blind spot of the pedestrian in a multi-lane road to prevent a collision accident with the pedestrian.

According to the present invention, by enabling a vehicle to guide whether the pedestrian can cross a road to the pedestrian, stability of the pedestrian can be improved.

According to the present invention, by providing walkable information of a pedestrian to a vehicle closest to a pedestrian, a collision accident between the vehicle and the pedestrian can be prevented.

According to the present invention, by estimating a pedestrian's crossing time in consideration of the pedestrian's status, when the pedestrian uses a crosswalk, a safety level can be enhanced.

According to the present invention, an autonomous vehicle or a server recognizes a pedestrian location received through a pedestrian terminal and determines the pedestrian's type. According to the present invention, by slowing down a driving speed of vehicles approaching the pedestrian by transmitting the pedestrian's type to other vehicles, when the pedestrian crosses a road, s walking safety level of the pedestrian can be improved.

According to the present invention, a vehicle can estimate an estimated crossing time when a pedestrian crosses a road according to the pedestrian's type to transmit the estimated crossing time to other vehicle.

Other vehicles, having received a type and estimated crossing time information of the pedestrian determine deceleration and whether to continue driving and respond to a pedestrian recognition vehicle. The pedestrian recognition vehicle determines whether the pedestrian can cross a road and a pedestrian safety level when the pedestrian crosses a road based on entry information (whether to continue driving) of the vehicle, having received the response.

A vehicle in a lane closest to a pedestrian or in a lane in an advancing direction of the pedestrian outputs walking guide information to a display visible to the pedestrian to guide the pedestrian's safe road crossing. When the pedestrian crosses a road, by moving a walking guide information display location according to a movement direction of the pedestrian, a guide display can be together moved to the vehicle front.

The vehicle monitors a pedestrian status in real time and adjusts an estimated crossing time when a status change of a pedestrian occurs that causes a moving speed change of the pedestrian in a process in which the pedestrian crosses a road, and notifies again other vehicle of the adjusted estimated crossing time to enable the other vehicle to appropriately handle to the moving speed change of the pedestrian.

A pedestrian terminal may output walking guide information received from a vehicle to a pedestrian.

The effects of the present invention are not limited to the above-described effects and the other effects will be understood by those skilled in the art from the description of claims.

### DESCRIPTION OF DRAWINGS

FIG. 1 illustrates an example of a basic operation of an autonomous vehicle and a 5G network in a 5G communication system.

FIG. 2 illustrates an example of an application operation of an autonomous vehicle and a 5G network in a 5G communication system.

FIGS. 3 to 6 illustrate an example of an operation of an autonomous vehicle using 5G communication.

FIG. 7 is a diagram illustrating an external shape of a vehicle according to an embodiment of the present invention.

FIG. 8 is a diagram illustrating a vehicle when viewed in various angles of the outside according to an embodiment of the present invention.

FIGS. 9 and 10 are diagrams illustrating the inside of a vehicle according to an embodiment of the present invention.

FIGS. 11 and 12 are diagrams illustrating examples of objects related to driving of a vehicle according to an embodiment of the present invention;

FIG. 13 is a block diagram illustrating in detail a vehicle according to an embodiment of the present invention;

FIG. 14 is a diagram illustrating V2X communication.

FIG. 15 is a diagram illustrating a pedestrian guidance system according to an embodiment of the present invention.

FIG. 16 is a flowchart illustrating step-by-step a control process of a walking guide method according to an embodiment of the present invention.

FIGS. 17A and 17B are diagrams illustrating the walking guide method of FIG. 16.

FIG. 18 is a diagram illustrating an example of a deceleration section.

FIGS. 19A to 20B are diagrams illustrating an example in which a vehicle close to a pedestrian outputs walking guide information when the pedestrian crosses a road.

FIG. 21 is a diagram illustrating an example of walking guide information output to a display of a pedestrian terminal.

FIG. 22 is a flowchart illustrating in detail a pedestrian recognizing and determining method.

FIG. 23 is a flowchart illustrating a walking guide method according to a pedestrian status change.

FIG. 24 is a diagram illustrating an embodiment of determining a pedestrian type in a server.

### MODE FOR INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

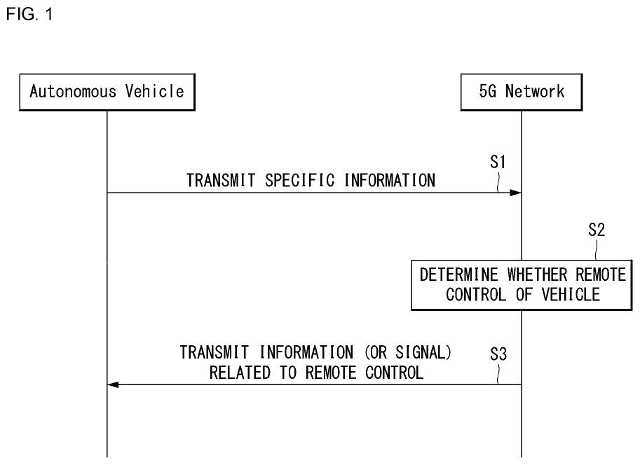

FIG. 1 illustrates an example of a basic operation of an autonomous vehicle and a 5G network in a 5G communication system.

The autonomous vehicle transmits specific information to the 5G network (S1).

The specific information may include autonomous driving related information.

The autonomous driving related information may be information directly related to driving control of the vehicle. For example, the autonomous driving related information may include at least one of object data indicating an object at a periphery of the vehicle, map data, vehicle status data, vehicle location data, and driving plan data.

The autonomous driving related information may further include service information necessary for autonomous driving. For example, the specific information may include information on a destination and a safety grade of the vehicle input through a user terminal. The 5G network may determine whether the remote control of the vehicle (S2).

Here, the 5G network may include a server or a module for performing the autonomous driving related remote control.

The 5G network may transmit information (or signal) related to the remote control to the autonomous vehicle (S3).

As described above, information related to the remote control may be a signal directly applied to the autonomous vehicle and may further include service information required for autonomous driving. In an embodiment of the present invention, the autonomous vehicle may receive service information such as a danger section and each section insurance selected on a driving route through a server connected to the 5G network to provide a service related to autonomous driving.

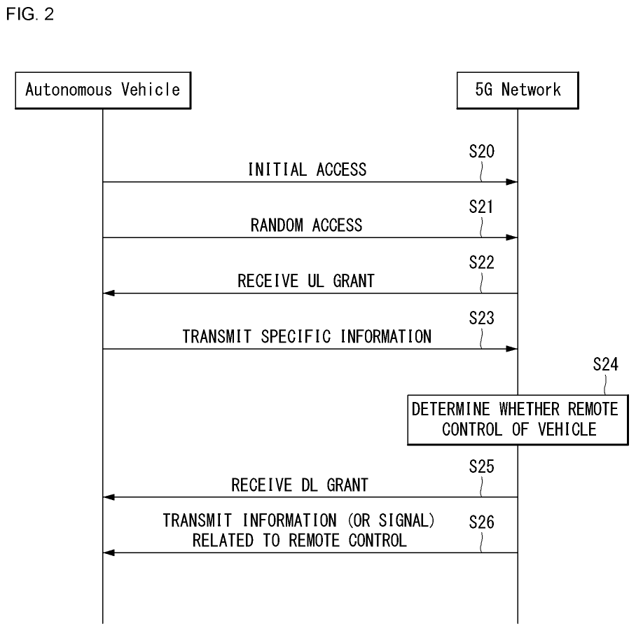

Hereinafter, in FIGS. 2 to 6, in order to provide an insurance service that may be applied to each section in an autonomous driving process according to an embodiment of the present invention, a required process (e.g., an initial access procedure between the vehicle and the 5G network) for 5G communication between the autonomous vehicle and the 5G network is described.

FIG. 2 illustrates an example of an application operation of an autonomous vehicle and a 5G network in a 5G communication system.

The autonomous vehicle performs an initial access procedure with the 5G network (S20).

The initial access procedure includes a process for obtaining system information and cell search for obtaining a downlink (DL) operation.

The autonomous vehicle performs a random access procedure with the 5G network (S21).

The random access process includes preamble transmission and random access response reception processes for uplink (UL) synchronization acquisition or UL data transmission. The 5G network transmits UL grant for scheduling transmission of specific information to the autonomous vehicle (S22).

The UL grant reception includes a process of receiving time/frequency resource scheduling for transmission of UL data to the 5G network.

The autonomous vehicle transmits specific information to the 5G network based on the UL grant (S23).

The 5G network determines whether the remote control of the vehicle (S24).

In order to receive a response to specific information from the 5G network, the autonomous vehicle receives DL grant through a physical downlink control channel (S25).

The 5G network transmits information (or signal) related to the remote control to the autonomous vehicle based on the DL grant (S26).

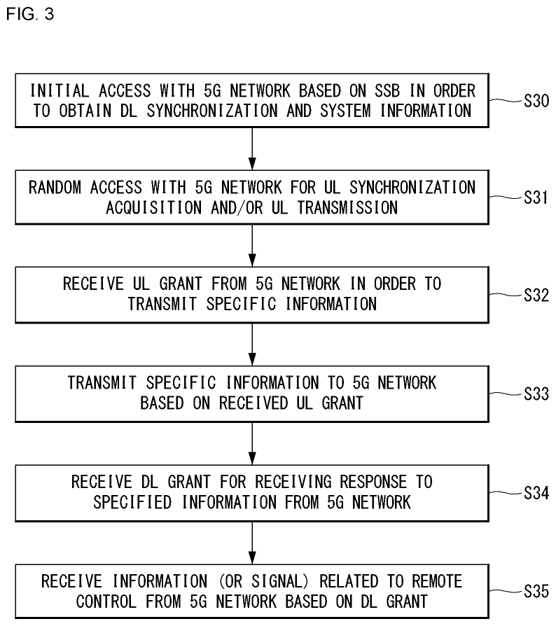

FIG. 3 illustrates an example in which an initial access process and/or a random access process and a DL grant reception process of an autonomous vehicle and 5G communication are coupled through processes of S20 to S26, but the present invention is not limited thereto.

For example, the initial access process and/or the random access process may be performed through the processes of S20, S22, S23, and S24. Further, for example, the initial access process and/or the random access process may be performed through processes of S21, S22, S23, S24, and S26. Further, a coupling process of an AI operation and a DL grant reception process may be performed through S23, S24, S25, and S26.

Further, FIG. 2 illustrates an autonomous vehicle operation through S20 to S26, and the present invention is not limited thereto.

For example, in the autonomous vehicle operation, S20, S21, S22, and S25 may be selectively coupled to S23 and S26 and be operated. Further, for example, the autonomous vehicle operations may be configured with S21, S22, S23, and S26. Further, for example, the autonomous vehicle operations may be configured with S20, S21, S23, and S26. Further, for example, the autonomous vehicle operations may be configured with S22, S23, S25, and S26.

FIGS. 3 to 6 illustrate an example of an autonomous vehicle operation using 5G communication.

Referring to FIG. 3, in order to obtain DL synchronization and system information, the autonomous vehicle including an autonomous module performs an initial access procedure with the 5G network based on a synchronization signal block (SSB) (S30).

The autonomous vehicle performs a random access procedure with the 5G network for UL synchronization acquisition and/or UL transmission (S31).

In order to transmit specific information, the autonomous vehicle receives UL grant from the 5G network (S32).

The autonomous vehicle transmits specific information to the 5G network based on the UL grant (S33).

The autonomous vehicle receives DL grant for receiving a response to the specified information from the 5G network (S34).

The autonomous vehicle receives information (or signal) related to the remote control from the 5G network based on DL grant (S35).

A Beam Management (BM) process may be added to S30, a beam failure recovery process related to physical random access channel (PRACH) transmission may be added to S31, a QCL relationship may be added to S32 in relation to a beam reception direction of a physical downlink control channel (PDCCH) including UL grant, and a QCL relationship may be added to S33 in relation to a beam transmission direction of a physical uplink control channel (PUCCH)/physical uplink shared channel (PUSCH) including specific information. Further, a QCL relationship may be added to S34 in relation to a beam reception direction of the PDCCH including DL grant.

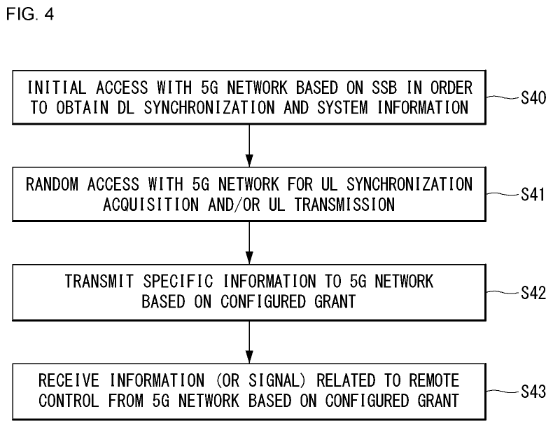

Referring to FIG. 4, in order to obtain DL synchronization and system information, the autonomous vehicle performs an initial access procedure with the 5G network based on the SSB (S40).

The autonomous vehicle performs a random access procedure with the 5G network for UL synchronization acquisition and/or UL transmission (S41).

The autonomous vehicle transmits specific information to the 5G network based on configured grant (S42).

The autonomous vehicle receives information (or signal) related to the remote control from the 5G network based on the configured grant (S43).

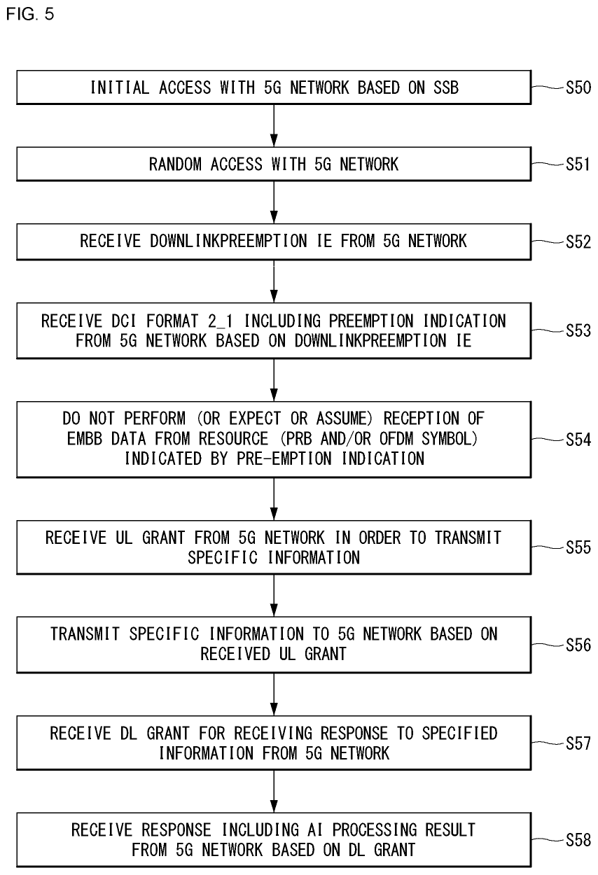

Referring to FIG. 5, in order to obtain DL synchronization and system information, the autonomous vehicle performs an initial access procedure with the 5G network based on the SSB (S50).

The autonomous vehicle performs a random access procedure with the 5G network for UL synchronization acquisition and/or UL transmission (S51).

The autonomous vehicle receives DownlinkPreemption IE from the 5G network (S52).

The autonomous vehicle receives a DCI format 2_1 including a preemption indication from the 5G network based on the DownlinkPreemption IE (S53).

The autonomous vehicle does not perform (or expect or assume) reception of eMBB data from a resource (PRB and/or OFDM symbol) indicated by the pre-emption indication (S54).

In order to transmit specific information, the autonomous vehicle receives UL grant from the 5G network (S55).

The autonomous vehicle transmits specific information to the 5G network based on the UL grant (S56).

The autonomous vehicle receives DL grant for receiving a response to the specified information from the 5G network (S57).

The autonomous vehicle receives information (or signal) related to the remote control from the 5G network based on DL grant (S58).

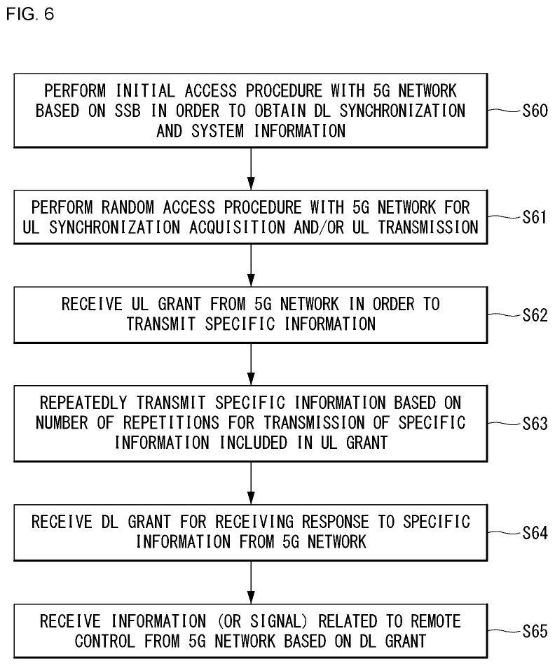

Referring to FIG. 6, in order to obtain DL synchronization and system information, the autonomous vehicle performs an initial access procedure with the 5G network based on the SSB (S60).

The autonomous vehicle performs a random access procedure with the 5G network for UL synchronization acquisition and/or UL transmission (S61).

In order to transmit specific information, the autonomous vehicle receives UL grant from the 5G network (S62).

The UL grant includes information on the number of repetitions of transmission of the specific information, and the specific information is repeatedly transmitted based on the information on the repetition number (S63).

The autonomous vehicle transmits specific information to the 5G network based on the UL grant.

Repeated transmission of specific information is performed through frequency hopping, first specific information may be transmitted in a first frequency resource, and second specific information may be transmitted in a second frequency resource.

The specific information may be transmitted through a narrowband of 6 resource blocks (RB) or 1RB.

The autonomous vehicle receives DL grant for receiving a response to specific information from the 5G network (S64).

The autonomous vehicle receives information (or signal) related to the remote control from the 5G network based on DL grant (S65).

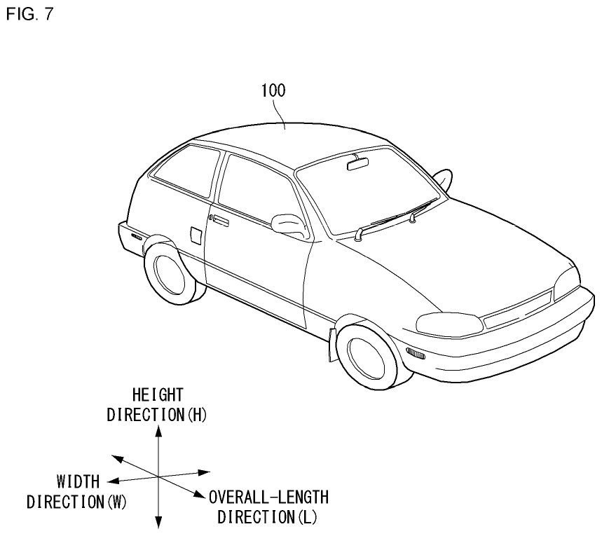

The foregoing 5G communication technology may be applied in combination with methods proposed in the present specification to be described later in FIGS. 7 to 24 or may be supplemented for specifying or for clearly describing technical characteristics of the methods proposed in the present specification.

A vehicle described in the present specification may be connected to an external server through a communication network and move along a preset route without a driver's intervention using autonomous driving technology. The vehicle of the present invention may be implemented into an internal combustion vehicle having an engine as a power source, a hybrid vehicle having an engine and an electric motor as a power source, and an electric vehicle having an electric motor as a power source.

In the following embodiments, a pedestrian means a person who carries a pedestrian terminal and crosses a road. A user may be a driver or a passenger of a vehicle. The pedestrian terminal may be a terminal, for example, a smart phone in which a pedestrian may carry and that may transmit location information and that may transmit and receive a signal to and from a vehicle and/or an external device through a communication network.

At least one of an autonomous vehicle, a user terminal, and a server of the present invention may be connected to or fused with an Artificial Intelligence (AI) module, a drone (Unmanned Aerial Vehicle (UAV)), a robot, an augmented reality (AR) device, a virtual reality (VR) device, and a device related to a 5G service.

For example, the autonomous vehicle may operate in connection with at least one artificial intelligence (AI) and robot included in the vehicle.

For example, the vehicle may mutually operate with at least one robot. The robot may be an Autonomous Mobile Robot (AMR). The mobile robot is capable of moving by itself to be free to move, and has a plurality of sensors for avoiding obstacles during driving to drive while avoiding obstacles. The moving robot may be a flight type robot (e.g., drone) having a flying device. The moving robot may be a wheel type robot having at least one wheel and moving through a rotation of the wheel. The moving robot may be a leg robot having at least one leg and moving using the leg.

The robot may function as a device that supplements convenience of a vehicle user. For example, the robot may perform a function of moving baggage loaded in the vehicle to a final destination of the user. For example, the robot may perform a function of guiding a route to a final destination to a user who gets off the vehicle. For example, the robot may perform a function of transporting a user who gets off the vehicle to a final destination.

At least one electronic device included in the vehicle may communicate with the robot through a communication device.

At least one electronic device included in the vehicle may provide data processed in at least one electronic device included in the vehicle to the robot. For example, at least one electronic device included in the vehicle may provide at least one of object data indicating an object at a periphery of the vehicle, map data, vehicle status data, vehicle location data, and driving plan data to the robot.

At least one electronic device included in the vehicle may receive data processed in the robot from the robot. At least one electronic device included in the vehicle may receive at least one of sensing data generated in the robot, object data, robot status data, robot location data, and movement plan data of the robot.

At least one electronic device included in the vehicle may generate a control signal based on data received from the robot. For example, at least one electronic device included in the vehicle may compare information on the object generated in the object detecting device and information on an object generated by the robot and generate a control signal based on a comparison result. At least one electronic device included in the vehicle may generate a control signal so that interference does not occur between a moving route of the vehicle and a moving route of the robot.

At least one electronic device included in the vehicle may include a software module or a hardware module (hereinafter, artificial intelligence module) that implements artificial intelligence (AI). At least one electronic device included in the vehicle may use data that input the obtained data to the artificial intelligence module and that are output from the artificial intelligence module.

The AI module may perform machine learning of input data using at least one artificial neural network (ANN). The AI module may output driving plan data through machine learning of the input data.

At least one electronic device included in the vehicle may generate a control signal based on data output from the AI module.

According to an embodiment, at least one electronic device included in the vehicle may receive data processed by artificial intelligence from an external device through the communication device. At least one electronic device included in the vehicle may generate a control signal based on data processed by artificial intelligence.

Hereinafter, various embodiments of the present specification will be described in detail with reference to the attached drawings.

Referring to FIGS. 7 to 13, an overall length means a length from the front to the rear of a vehicle 100, a width means a width of the vehicle 100, and a height means a length from a lower portion of a wheel to a loop of the vehicle 100. In FIG. 7, an overall length direction L means a direction to be the basis of overall length measurement of the vehicle 100, a width direction W means a direction to be the basis of width measurement of the vehicle 100, and a height direction H means a direction to be the basis of height measurement of the vehicle 100. In FIGS. 7 to 12, the vehicle is illustrated in a sedan type, but it is not limited thereto.

The vehicle 100 may be remotely controlled by an external device. The external device may be interpreted as a server. When it is determined that the remote control of the vehicle 100 is required, the server may perform the remote control of the vehicle 100.

A driving mode of the vehicle 100 may be classified into a manual mode, an autonomous mode, or a remote control mode according to a subject of controlling the vehicle 100. In the manual mode, the driver may directly control the vehicle to control vehicle driving. In the autonomous mode, a controller 170 and an operation system 700 may control driving of the vehicle 100 without intervention of the driver. In the remote control mode, the external device may control driving of the vehicle 100 without intervention of the driver.

The user may select one of an autonomous mode, a manual mode, and a remote control mode through a user interface device 200.

The vehicle 100 may be automatically switched to one of an autonomous mode, a manual mode, and a remote control mode based on at least one of driver status information, vehicle driving information, and vehicle status information.

The driver status information may be generated through the user interface device 200 to be provided to the controller 170. The driver status information may be generated based on an image and biometric information on the driver detected through an internal camera 220 and a biometric sensor 230. For example, the driver status information may include a line of sight, a facial expression, and a behavior of the driver obtained from an image obtained through the internal camera 220 and driver location information. The driver status information may include biometric information of the user obtained through the biometric sensor 230. The driver status information may represent a direction of a line of sight of the driver, whether drowsiness of the driver, and the driver's health and emotional status.

The vehicle driving information may include location information of the vehicle 100, posture information of the vehicle 100, information on another vehicle OB11 received from the another vehicle OB11, information on a driving route of the vehicle 100, or navigation information including map information.

The vehicle driving information may include a current location of the vehicle 100 on a route to a destination, a type, a location, and a movement of an object existing at a periphery of the vehicle 100, and whether there is a lane detected at a periphery of the vehicle 100. Further, the vehicle driving information may represent driving information of another vehicle 100, a space in which stop is available at a periphery of the vehicle 100, a possibility in which the vehicle and the object may collide, pedestrian or bike information detected at a periphery of the vehicle 100, road information, a signal status at a periphery of the vehicle 100, and a movement of the vehicle 100.

The vehicle driving information may be generated through connection with at least one of an object detection device 300, a communication device 400, a navigation system 770, a sensing unit 120, and an interface unit 130 to be provided to the controller 170.

The vehicle status information may be information related to a status of various devices provided in the vehicle 100. For example, the vehicle status information may include information on a charge status of the battery, information on an operating status of the user interface device 200, the object detection device 300, the communication device 400, a maneuvering device 500, a vehicle drive device 600, and an operation system 700, and information on whether there is abnormality in each device.

The vehicle status information may represent whether a Global Positioning System (GPS) signal of the vehicle 100 is normally received, whether there is abnormality in at least one sensor provided in the vehicle 100, or whether each device provided in the vehicle 100 normally operates.

A control mode of the vehicle 100 may be switched from a manual mode to an autonomous mode or a remote control mode, from an autonomous mode to a manual mode or a remote control mode, or from a remote control mode to a manual mode or an autonomous mode based on object information generated in the object detection device 300.

The control mode of the vehicle 100 may be switched from a manual mode to an autonomous mode or from an autonomous mode to a manual mode based on information received through the communication device 400.

The control mode of the vehicle 100 may be switched from a manual mode to an autonomous mode or from an autonomous mode to a manual mode based on information, data, and a signal provided from an external device.

When the vehicle 100 is driven in an autonomous mode, the vehicle 100 may be driven under the control of the operation system 700. In the autonomous mode, the vehicle 100 may be driven based on information generated in the driving system 710, the parking-out system 740, and the parking system 750.

When the vehicle 100 is driven in a manual mode, the vehicle 100 may be driven according to a user input that is input through the maneuvering device 500.

When the vehicle 100 is driven in a remote control mode, the vehicle 100 may receive a remote control signal transmitted by the external device through the communication device 400. The vehicle 100 may be controlled in response to the remote control signal.

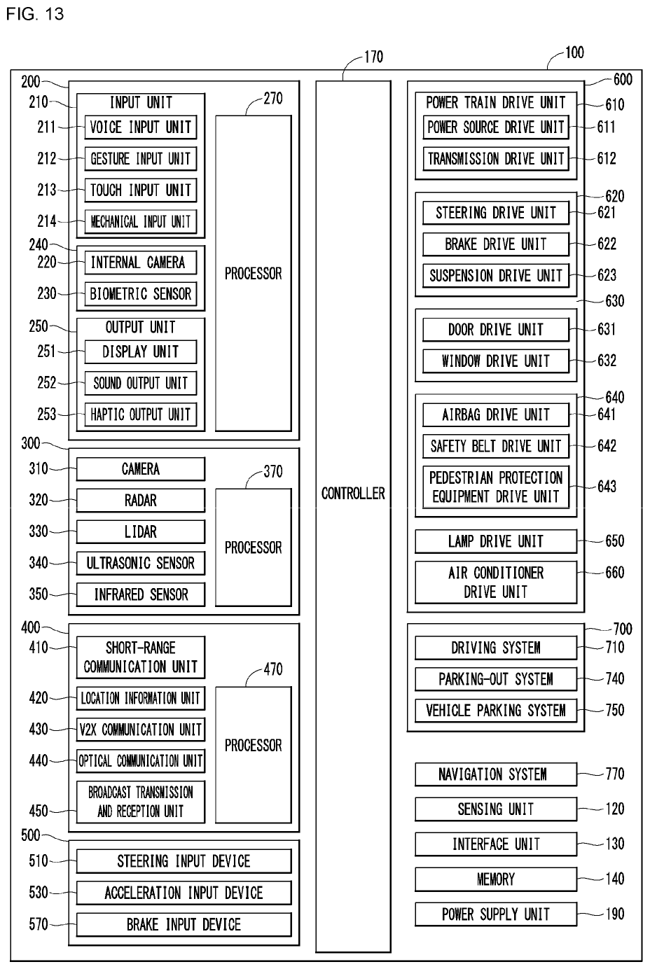

Referring to FIG. 13, the vehicle 100 may include the user interface device 200, the object detection device 300, the communication device 400, the maneuvering device 500, a vehicle drive device 600, the operation system 700, a navigation system 770, a sensing unit 120, an interface 130, a memory 140, a controller 170, and a power supply unit 190.

In addition to the components illustrated in FIG. 13, other components may be further included or some components may be omitted.

The user interface device 200 is provided to support communication between the vehicle 100 and a user. The user interface device 200 may receive a user input, and provide information generated in the vehicle 100 to the user. The vehicle 100 may enable User Interfaces (UI) or User Experience (UX) through the user interface device 200.

The user interface device 200 may include an input unit 210, an internal camera 220, a biometric sensor 230, an output unit 250, and a processor 270.

The input unit 210 is configured to receive a user command from a user, and data collected in the input unit 210 may be analyzed by the processor 270 and then recognized as a control command of the user.

The input unit 210 may be disposed inside the vehicle 100. For example, the input unit 210 may be disposed in a region of a steering wheel, a region of an instrument panel, a region of a seat, a region of each pillar, a region of a door, a region of a center console, a region of a head lining, a region of a sun visor, a region of a windshield, or a region of a window.

The input unit 210 may include a voice input unit 211, a gesture input unit 212, a touch input unit 213, and a mechanical input unit 214.

The voice input unit 211 may convert a voice input of a user into an electrical signal. The converted electrical signal may be provided to the processor 270 or the controller 170. The voice input unit 211 may include one or more microphones.

The gesture input unit 212 may convert a gesture input of a user into an electrical signal. The converted electrical signal may be provided to the processor 270 or the controller 170.

The gesture input unit 212 may sense the 3D gesture input. To this end, the gesture input unit 212 may include a plurality of light emitting units for outputting infrared light, or a plurality of image sensors.

The gesture input unit 212 may sense the 3D gesture input by employing a Time of Flight (TOF) scheme, a structured light scheme, or a disparity scheme.

The touch input unit 213 may convert a user's touch input into an electrical signal. The converted electrical signal may be provided to the processor 270 or the controller 170. The touch input unit 213 may include a touch sensor for sensing a touch input of a user. The touch input unit 210 may be formed integral with a display unit 251 to implement a touch screen. The touch screen may provide an input interface and an output interface between the vehicle 100 and the user.

The mechanical input unit 214 may include at least one selected from among a button, a dome switch, a jog wheel, and a jog switch. An electrical signal generated by the mechanical input unit 214 may be provided to the processor 270 or the controller 170. The mechanical input unit 214 may be located on a steering wheel, a center fascia, a center console, a cockpit module, a door, etc.

An occupant sensor 240 may detect an occupant in the vehicle 100. The occupant sensor 240 may include the internal camera 220 and the biometric sensor 230.

The internal camera 220 may acquire images of the inside of the vehicle 100. The processor 270 may sense a user's state based on the images of the inside of the vehicle 100.

The processor 270 may acquire information on the eye gaze, the face, the behavior, the facial expression, and the location of the user from an image of the inside of the vehicle 100. The processor 270 may sense a gesture of the user from the image of the inside of the vehicle 100. The processor 270 may provide the driver state information to the controller 170,

The biometric sensor 230 may acquire biometric information of the user. The biometric sensor 230 may include a sensor for acquire biometric information of the user, and may utilize the sensor to acquire finger print information, heart rate information, brain wave information etc. of the user. The biometric information may be used to authenticate a user or determine the user's condition.

The processor 270 may determine a driver's state based on the driver's biometric information. The driver state information may indicate whether the driver is in faint, dozing off, excited, or in an emergency situation. The processor 270 may provide the driver state information, acquired based on the driver's biometric information, to the controller 170.

The output unit 250 is configured to generate a visual, audio, or tactile output. The output unit 250 may include at least one selected from among a display unit 251, a sound output unit 252, and a haptic output unit 253.

The display unit 251 may display an image signal including various types of information. The display unit 251 may include at least one selected from among a Liquid Crystal Display (LCD), a Thin Film Transistor-Liquid Crystal Display (TFT LCD), an Organic Light-Emitting Diode (OLED), a flexible display, a 3D display, and an e-ink display.

The display unit 251 may form an inter-layer structure together with the touch input unit 213 to implement a touch screen. The display unit 251 may be implemented as a Head Up Display (HUD). When implemented as a HUD, the display unit 251 may include a projector module in order to output information through an image projected on a windshield or a window.

The display unit 251 may include a transparent display. The transparent display may be attached on the windshield or the window. In order to achieve the transparency, the transparent display may include at least one selected from among a transparent Thin Film Electroluminescent (TFEL) display, an Organic Light Emitting Diode (OLED) display, a transparent Liquid Crystal Display (LCD), a transmissive transparent display, and a transparent Light Emitting Diode (LED) display. The transparency of the transparent display may be adjustable.

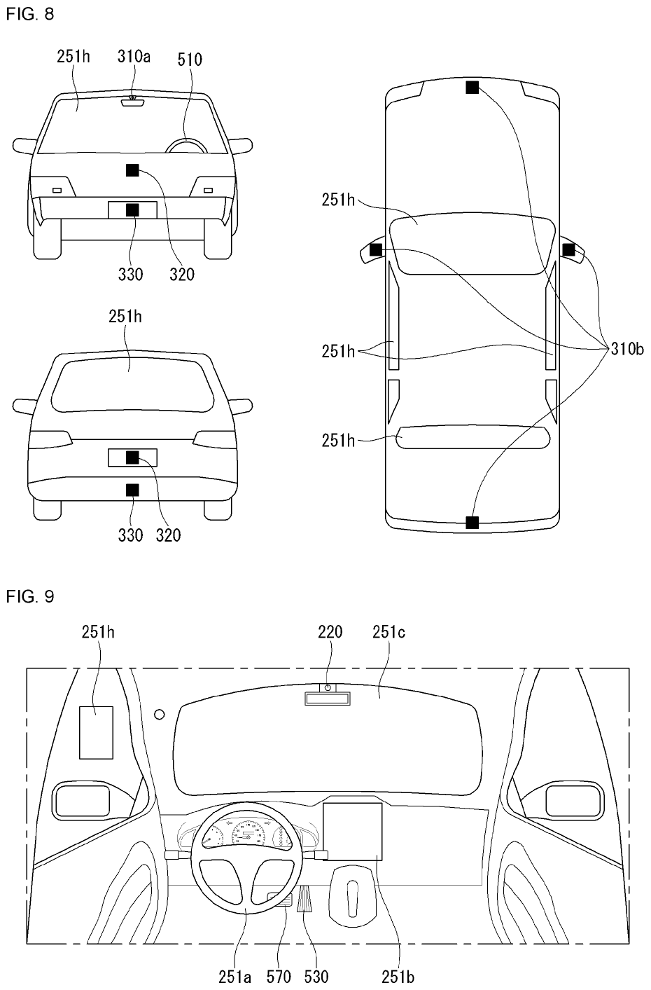

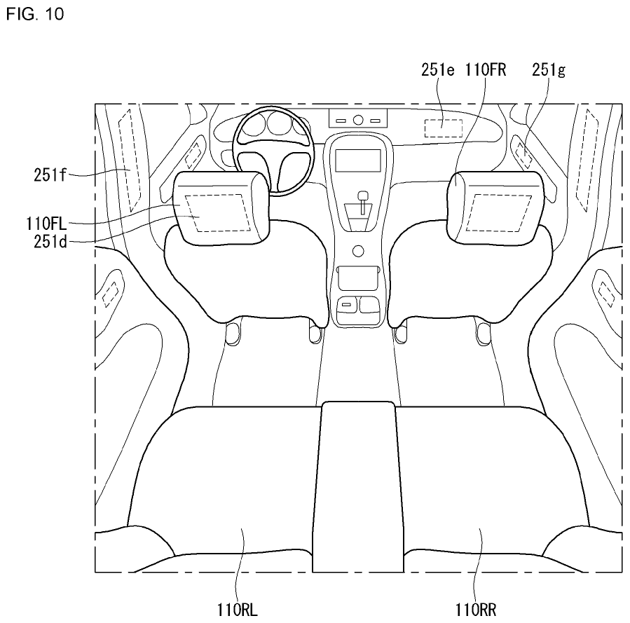

The display unit 251 may include a plurality of displays 251a to 251g as shown in FIGS. 8 and 10. The display unit 251 may be disposed in a region 251a of a steering wheel, a region 251b or 251e of an instrument panel, a region 251d of a seat, a region 251f of each pillar, a region 251g of a door, a region of a center console, a region of a head lining, a region of a sun visor, a region 251c of a windshield, or a region 251h of a window. The display 251h disposed in the window may be disposed in each of the front window, the rear window, and the side window of the vehicle 100.

The sound output unit 252 converts an electrical signal from the processor 270 or the controller 170 into an audio signal, and outputs the audio signal. To this end, the sound output unit 252 may include one or more speakers.

The haptic output unit 253 generates a tactile output. For example, the haptic output unit 253 may operate to vibrate a steering wheel, a safety belt, and seats 110FL, 110FR, 110RL, and 110RR so as to allow a user to recognize the output.

The processor 270 may control the overall operation of each unit of the user interface device 200. In a case where the user interface device 200 does not include the processor 270, the user interface device 200 may operate under control of the controller 170 or a processor of a different device inside the vehicle 100.

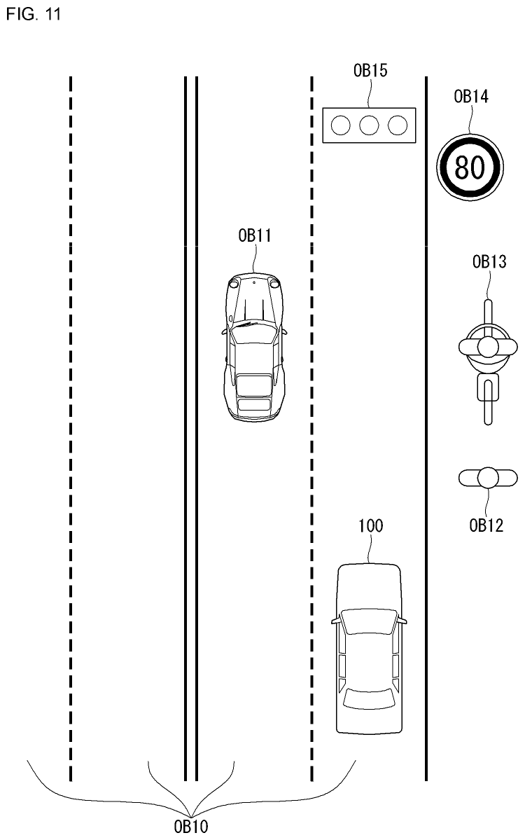

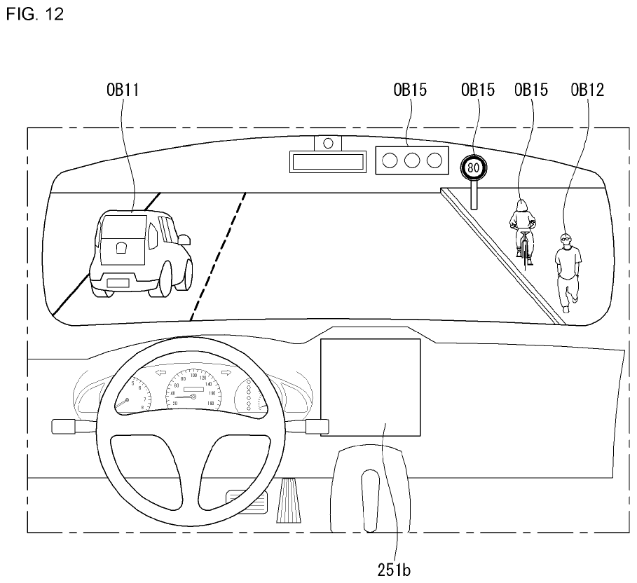

The object detection device 300 is configured to detect an object outside the vehicle 100. The object may include various objects related to travelling of the vehicle 100. For example, referring to FIGS. 11 and 12, an object o may include a lane OB10, a nearby vehicle OB11, a pedestrian OB12, a two-wheeled vehicle OB13, a traffic sign OB14 and OB15, a light, a road, a structure, a bump, a geographical feature, an animal, etc.

The lane OB10 may be a lane in which the vehicle 100 is traveling, a lane next to the lane in which the vehicle 100 is traveling, or a lane in which a different vehicle is travelling from the opposite direction. The lane OB10 may include left and right lines that define the lane.

The nearby vehicle OB11 may be a vehicle that is travelling in the vicinity of the vehicle 100. The nearby vehicle OB11 may be a vehicle within a predetermined distance from the vehicle 100. For example, the nearby vehicle OB11 may be a vehicle that is travelling ahead or behind the vehicle 100.

The pedestrian OB12 may be a person in the vicinity of the vehicle 100. The pedestrian OB12 may be a person within a predetermined distance from the vehicle 100. For example, the pedestrian OB12 may be a person on a sidewalk or on the roadway.

The two-wheeled vehicle OB13 is a vehicle that is located in the vicinity of the vehicle 100 and moves with two wheels. The two-wheeled vehicle OB13 may be a vehicle that has two wheels within a predetermined distance from the vehicle 100. For example, the two-wheeled vehicle OB13 may be a motorcycle or a bike on a sidewalk or the roadway.

The traffic sign may include a traffic light OB15, a traffic sign plate OB14, and a pattern or text painted on a road surface.

The light may be light generated by a lamp provided in the nearby vehicle.

The light may be light generated by a street light. The light may be solar light.

The road may include a road surface, a curve, and slopes, such as an upward slope and a downward slope.

The structure may be a body located around the road in the state of being fixed onto the ground. For example, the structure may include a streetlight, a roadside tree, a building, a bridge, a traffic light, a curb, a guardrail, etc.

The geographical feature may include a mountain and a hill.

The object may be classified as a movable object or a stationary object. The movable object may include a nearby vehicle and a pedestrian. The stationary object may include a traffic sign, a road, and a fixed structure.

The object detection device 300 may include a camera 310, a radar 320, a lidar 330, an ultrasonic sensor 340, an infrared sensor 350, and a processor 370.

The camera 310 may photograph an external environment of the vehicle 100 and outputs a video signal showing the external environment of the vehicle 100. The camera 310 may photograph a pedestrian around the vehicle 100.

The camera 310 may be located at an appropriate position outside the vehicle 100 in order to acquire images of the outside of the vehicle 100. The camera 310 may be a mono camera, a stereo camera 310a, an Around View Monitoring (AVM) camera 310b, or a 360-degree camera.

The camera 310 may be disposed near a front windshield in the vehicle 100 in order to acquire images of the front of the vehicle 100. The camera 310 may be disposed around a front bumper or a radiator grill. The camera 310 may be disposed near a rear glass in the vehicle 100 in order to acquire images of the rear of the vehicle 100. The camera 310 may be disposed around a rear bumper, a trunk, or a tailgate. The camera 310 may be disposed near at least one of the side windows in the vehicle 100 in order to acquire images of the side of the vehicle 100. The camera 310 may be disposed around a side mirror, a fender, or a door. The camera 310 may provide an acquired image to the processor 370.

The radar 320 may include an electromagnetic wave transmission unit and an electromagnetic wave reception unit. The radar 320 may be realized as pulse radar or continuous wave radar depending on the principle of emission of an electronic wave. The radar 320 may be realized as Frequency Modulated Continuous Wave (FMCW) type radar or Frequency Shift Keying (FSK) type radar depending on the waveform of a signal.

The radar 320 may detect an object through the medium of an electromagnetic wave by employing a time of flight (TOF) scheme or a phase-shift scheme, and may detect a location of the detected object, the distance to the detected object, and the speed relative to the detected object. The radar 320 may be located at an appropriate position outside the vehicle 100 in order to sense an object located in front of the vehicle 100, an object located to the rear of the vehicle 100, or an object located to the side of the vehicle 100.

The lidar 330 may include a laser transmission unit and a laser reception unit. The lidar 330 may be implemented by the TOF scheme or the phase-shift scheme. The lidar 330 may be implemented as a drive type lidar or a non-drive type lidar. When implemented as the drive type lidar, the lidar 300 may rotate by a motor and detect an object in the vicinity of the vehicle 100. When implemented as the non-drive type lidar, the lidar 300 may utilize a light steering technique to detect an object located within a predetermined distance from the vehicle 100. The vehicle 100 may include a plurality of non-driven type lidar 330.

The lidar 330 may detect an object through the medium of laser light by employing the TOF scheme or the phase-shift scheme, and may detect a location of the detected object, the distance to the detected object, and the speed relative to the detected object. The lidar 330 may be located at an appropriate position outside the vehicle 100 in order to sense an object located in front of the vehicle 100, an object located to the rear of the vehicle 100, or an object located to the side of the vehicle 100.

The ultrasonic sensor 340 may include an ultrasonic wave transmission unit and an ultrasonic wave reception unit. The ultrasonic sensor 340 may detect an object based on an ultrasonic wave, and may detect a location of the detected object, the distance to the detected object, and the speed relative to the detected object. The ultrasonic sensor 340 may be located at an appropriate position outside the vehicle 100 in order to detect an object located in front of the vehicle 100, an object located to the rear of the vehicle 100, and an object located to the side of the vehicle 100.

The infrared sensor 350 may include an infrared light transmission unit and an infrared light reception unit. The infrared sensor 340 may detect an object based on infrared light, and may detect a location of the detected object, the distance to the detected object, and the speed relative to the detected object. The infrared sensor 350 may be located at an appropriate position outside the vehicle 100 in order to sense an object located in front of the vehicle 100, an object located to the rear of the vehicle 100, or an object located to the side of the vehicle 100.

The processor 370 may control the overall operation of each unit of the object detection device 300. The processor 370 may detect and track an object based on acquired images. The processor 370 may calculate the distance to the object and the speed relative to the object, determine a type, location, size, shape, color, moving path of the object, and determine a sensed text.

The processor 370 may detect and track an object based on a reflection electromagnetic wave which is formed as a result of reflection a transmission electromagnetic wave by the object. Based on the electromagnetic wave, the processor 370 may, for example, calculate the distance to the object and the speed relative to the object.

The processor 370 may detect and track an object based on a reflection laser light which is formed as a result of reflection of transmission laser by the object. Based on the laser light, the processor 370 may calculate the distance to the object and the speed relative to the object.

The processor 370 may detect and track an object based on a reflection ultrasonic wave which is formed as a result of reflection of a transmission ultrasonic wave by the object. Based on the ultrasonic wave, the processor 370 may calculate the distance to the object and the speed relative to the object.

The processor 370 may detect and track an object based on reflection infrared light which is formed as a result of reflection of transmission infrared light by the object. Based on the infrared light, the processor 370 may calculate the distance to the object and the speed relative to the object.

The processor 370 may generate object information based on at least one of the following: an information acquired using the camera 310, a reflected electronic wave received using the radar 320, a reflected laser light received using the lidar 330, and a reflected ultrasonic wave received using the ultrasonic sensor 340, and a reflected infrared light received using the infrared sensor 350. The processor 370 may provide the object information to the controller 170.

The object information may be information about a type, location, size, shape, color, a moving path, and speed of an object existing around the vehicle 100 and information about a sensed text. The object information may indicate: whether a traffic line exists in the vicinity of the vehicle 100; whether any nearby vehicle is travelling while the vehicle 100 is stopped; whether there is a space in the vicinity of the vehicle 100 to stop; whether a vehicle and an object could collide; where a pedestrian or a bicycle is located with reference to the vehicle 100; a type of a roadway in which the vehicle 100 is travelling, a status of a traffic light in the vicinity of the vehicle 100, and movement of the vehicle 100.

The object detection device 300 may include a plurality of processors 370 or may not include the processor 370. For example, each of the camera 310, the radar 320, the lidar 330, the ultrasonic sensor 340, and the infrared sensor 350 may include its own processor.

The object detection device 300 may operate under control of the controller 170 or a processor inside the vehicle 100.

The communication device 400 is configured to perform communication with an external device. Here, the external device may be a nearby vehicle, a user's terminal, or a server.

To perform communication, the communication device 400 may include at least one selected from among a transmission antenna, a reception antenna, a Radio Frequency (RF) circuit capable of implementing various communication protocols, and an RF device.

The communication device 400 may include a short-range communication unit 410, a location information unit 420, a V2X communication unit 430, an optical communication unit 440, a broadcast transmission and reception unit 450, and a processor 470.

The short-range communication unit 410 is configured to perform short-range communication. The short-range communication unit 410 may support short-range communication using at least one selected from among Bluetooth [symbol] , Radio Frequency IDdentification (RFID), Infrared Data Association (IrDA), Ultra-WideBand (UWB), ZigBee, Near Field Communication (NFC), Wireless-Fidelity (Wi-Fi), Wi-Fi Direct, and Wireless USB (Wireless Universal Serial Bus).

The short-range communication unit 410 may form wireless area networks to perform short-range communication between the vehicle 100 and at least one external device.

The location information unit 420 is configured to acquire location information of the vehicle 100. For example, the location information unit 420 may include at least one of a Global Positioning System (GPS) module, a Differential Global Positioning System (DGPS) module, and a Carrier phase Differential GPS (CDGPS) module.

The V2X communication unit 430 is configured to perform wireless communication between a vehicle and a server (that is, vehicle to infra (V2I) communication), wireless communication between a vehicle and a nearby vehicle (that is, vehicle to vehicle (V2V) communication), or wireless communication between a vehicle and a pedestrian (that is, vehicle to pedestrian (V2P) communication).

The optical communication unit 440 is configured to perform communication with an external device through the medium of light. The optical communication unit 440 may include a light emitting unit, which converts an electrical signal into an optical signal and transmits the optical signal to the outside, and a light receiving unit which converts a received optical signal into an electrical signal. The light emitting unit may be integrally formed with a lamp provided included in the vehicle 100.

The broadcast transmission and reception unit 450 is configured to receive a broadcast signal from an external broadcasting management server or transmit a broadcast signal to the broadcasting management server through a broadcasting channel. The broadcasting channel may include a satellite channel, and a terrestrial channel. The broadcast signal may include a TV broadcast signal, a radio broadcast signal, and a data broadcast signal.

The processor 470 may control the overall operation of each unit of the communication device 400. The processor 470 may generate vehicle driving information based on information received through at least one of a short range communication unit 410, a location information unit 420, a V2X communication unit 430, an optical communication unit 440, and a broadcast transmitting and receiving unit 450. The processor 470 may generate vehicle driving information based on information on a location, model, driving route, speed, and various sensing values of another vehicle OB11 received from the other vehicle OB11. When information on various sensing values of the other vehicle OB11 is received, even if there is no separate sensor in the vehicle 100, the processor 470 may obtain information on a peripheral object of the vehicle 100.

In a case where the communication device 400 does not include the processor 470, the communication device 400 may operate under control of the controller 170 or a processor of a device inside of the vehicle 100.

The communication device 400 may implement a vehicle display device, together with the user interface device 200. In this case, the vehicle display device may be referred to as a telematics device or an Audio Video Navigation (AVN) device.

The controller 170 may transmit at least one of driver status information, vehicle status information, vehicle driving information, error information representing an error of the vehicle 100, and object information based on a signal received from the communication device 400, a user input received through the user interface device 200, and a remote control request signal to an external device. The remote control server may determine whether the remote control is required in the vehicle 100 based on information sent by the vehicle 100.

The controller 170 may control the vehicle 100 according to a control signal received from a remote control server through the communication device 400.

The maneuvering device 500 is configured to receive a user command for driving the vehicle 100. In the manual driving mode, the vehicle 100 may operate based on a signal provided by the maneuvering device 500.

The maneuvering device 500 may include a steering input device 510, an acceleration input device 530, and a brake input device 570.

The steering input device 510 may receive a user command for steering of the vehicle 100. The user command for steering may be a command corresponding to a specific steering angle. The steering input device 510 may take the form of a wheel to enable a steering input through the rotation thereof. In some implementations, the steering input device may be provided as a touchscreen, a touch pad, or a button.

The acceleration input device 530 may receive a user command for acceleration of the vehicle 100. The brake input device 570 may receive a user command for deceleration of the vehicle 100. Each of the acceleration input device 530 and the brake input device 570 may take the form of a pedal. In some implementations, the acceleration input device or the break input device may be configured as a touch screen, a touch pad, or a button.

The maneuvering device 500 may operate under control of the controller 170.

The vehicle drive device 600 is configured to electrically control the operation of various devices of the vehicle 100. The vehicle drive device 600 may include a power train drive unit 610, a chassis drive unit 620, a door/window drive unit 630, a safety apparatus drive unit 640, a lamp drive unit 650, and an air conditioner drive unit 660.

The power train drive unit 610 may control the operation of a power train. The power train drive unit 610 may include a power source drive unit 611 and a transmission drive unit 612.

The power source drive unit 611 may control a power source of the vehicle 100. In the case in which a fossil fuel-based engine is the power source, the power source drive unit 611 may perform electronic control of the engine. As such the power source drive unit 611 may control, for example, the output torque of the engine. The power source drive unit 611 may adjust the output toque of the engine under control of the controller 170.

The transmission drive unit 612 may control a transmission. The transmission drive unit 612 may adjust the state of the transmission. The transmission drive unit 612 may adjust a state of the transmission to a drive (D), reverse (R), neutral (N), or park (P) state. In some implementations, in a case where an engine is the power source, the transmission drive unit 612 may adjust a gear-engaged state to the drive position D.

The chassis drive unit 620 may control the operation of a chassis. The chassis drive unit 620 may include a steering drive unit 621, a brake drive unit 622, and a suspension drive unit 623.

The steering drive unit 621 may perform electronic control of a steering apparatus provided inside the vehicle 100. The steering drive unit 621 may change the direction of travel of the vehicle 100.

The brake drive unit 622 may perform electronic control of a brake apparatus provided inside the vehicle 100. For example, the brake drive unit 622 may reduce the speed of the vehicle 100 by controlling the operation of a brake located at a wheel. In some implementations, the brake drive unit 622 may control a plurality of brakes individually. The brake drive unit 622 may apply a different degree-braking force to each wheel.

The suspension drive unit 623 may perform electronic control of a suspension apparatus inside the vehicle 100. For example, when the road surface is uneven, the suspension drive unit 623 may control the suspension apparatus so as to reduce the vibration of the vehicle 100. In some implementations, the suspension drive unit 623 may control a plurality of suspensions individually.

The door/window drive unit 630 may perform electronic control of a door device or a window device inside the vehicle 100. The door/window drive unit 630 may include a door drive unit 631 and a window drive unit 632. The door drive unit 631 may control the door device. The door drive unit 631 may control opening or closing of a plurality of doors included in the vehicle 100. The door drive unit 631 may control opening or closing of a trunk or a tail gate. The door drive unit 631 may control opening or closing of a sunroof.

The window drive unit 632 may perform electronic control of the window device. The window drive unit 632 may control opening or closing of a plurality of windows included in the vehicle 100.

The safety apparatus drive unit 640 may perform electronic control of various safety apparatuses provided inside the vehicle 100. The safety apparatus drive unit 640 may include an airbag drive unit 641, a safety belt drive unit 642, and a pedestrian protection equipment drive unit 643.

The airbag drive unit 641 may perform electronic control of an airbag apparatus inside the vehicle 100. For example, upon detection of a dangerous situation, the airbag drive unit 641 may control an airbag to be deployed.

The safety belt drive unit 642 may perform electronic control of a seatbelt apparatus inside the vehicle 100. For example, upon detection of a dangerous situation, the safety belt drive unit 642 may control passengers to be fixed onto seats 110FL, 110FR, 110RL, and 110RR with safety belts.

The pedestrian protection equipment drive unit 643 may perform electronic control of a hood lift and a pedestrian airbag. For example, upon detection of a collision with a pedestrian, the pedestrian protection equipment drive unit 643 may control a hood lift and a pedestrian airbag to be deployed.

The lamp drive unit 650 may perform electronic control of various lamp apparatuses provided inside the vehicle 100.

The air conditioner drive unit 660 may perform electronic control of an air conditioner inside the vehicle 100.

The operation system 700 is a system for controlling the overall operation of the vehicle 100. The operation system 700 may operate in an autonomous mode. In a case where the operation system 700 is implemented as software, the operation system 700 may be a subordinate concept of the controller 170.

The operation system 700 may be a concept including at least one selected from among the user interface device 200, the object detection device 300, the communication device 400, the vehicle drive device 600, and the controller 170.

The driving system 710 may provide a control signal to the vehicle drive device 600 in response to reception of navigation information from the navigation system 770. The navigation information may include route information necessary for autonomous travel such as destination and waypoint information. The navigation information may include a map data, traffic information, and the like.

The driving system 710 may provide a control signal to the vehicle drive device 600 in response to reception of object information from the object detection device 300. The driving system 710 may provide a control signal to the vehicle drive device 600 in response to reception of a signal from an external device through the communication device 400.

The parking-out system 740 may park the vehicle 100 out of a parking space.

The parking-out system 740 may provide a control signal to the vehicle drive device 600 based on location information of the vehicle 100 and navigation information provided by the navigation system 770. The parking-out system 740 may provide a control signal to the vehicle drive device 600 based on object information provided by the object detection device 300. The parking-out system 740 may provide a control signal to the vehicle drive device 600 based on a signal provided by an external device received through the communication device 400.

The parking system 750 may park the vehicle 100 in a parking space. The vehicle parking system 750 may provide a control signal to the vehicle drive device 600 based on the navigation information provided by the navigation system 770. The parking system 750 may provide a control signal to the vehicle drive device 600 based on object information provided by the object detection device 300. The parking system 750 may provide a control signal to the vehicle drive device 600 based on a signal provided by an external device received through the communication device 400.

The navigation system 770 may provide navigation information. The navigation information may include at least one of the following: map information, information on a set destination, information on a route to the set destination, information on various objects along the route, lane information, and information on the current location of a vehicle. The navigation system 770 may include a memory and a processor. The memory may store navigation information. The processor may control the operation of the navigation system 770. The navigation system 770 may update pre-stored information by receiving information from an external device through the communication device 400. The navigation system 770 may be classified as an element of the user interface device 200.

The sensing unit 120 may sense the state of the vehicle. The sensing unit 120 may include an attitude sensor, a collision sensor, a wheel sensor, a speed sensor, a gradient sensor, a weight sensor, a heading sensor, a yaw sensor, a gyro sensor, a position module, a vehicle forward/reverse movement sensor, a battery sensor, a fuel sensor, a tire sensor, a steering sensor based on the rotation of the steering wheel, an in-vehicle temperature sensor, an in-vehicle humidity sensor, an ultrasonic sensor, an illumination sensor, an accelerator pedal position sensor, and a brake pedal position sensor. For example, the attitude sensor may include yaw sensor, roll sensor, pitch sensor, etc.

The sensing unit 120 may acquire sensing signals with regard to, for example, vehicle attitude information, vehicle collision information, vehicle driving direction information, vehicle location information (GPS information), vehicle angle information, vehicle speed information, vehicle acceleration information, vehicle tilt information, vehicle forward/reverse movement information, battery information, fuel information, tire information, vehicle lamp information, in-vehicle temperature information, in-vehicle humidity information, steering-wheel rotation angle information, out-of-vehicle illumination information, information about the pressure applied to an accelerator pedal, and information about the pressure applied to a brake pedal.

The sensing unit 120 may further include, for example, an accelerator pedal sensor, a pressure sensor, an engine speed sensor, an Air Flow-rate Sensor (AFS), an Air Temperature Sensor (ATS), a Water Temperature Sensor (WTS), a Throttle Position Sensor (TPS), a Top Dead Center (TDC) sensor, and a Crank Angle Sensor (CAS).

The interface 130 may serve as a passage for various kinds of external devices that are connected to the vehicle 100. For example, the interface 130 may have a port that is connectable to a mobile terminal and may be connected to the mobile terminal via the port. In this case, the interface 130 may exchange data with the mobile terminal.

The interface 130 may serve as a passage for the supply of electrical energy to a user's terminal connected thereto. When the user's terminal is electrically connected to the interface 130, the interface 130 may provide electrical energy, supplied from the power supply unit 190, to the user's terminal under control of the controller 170.

The memory 140 is electrically connected to the controller 170. The memory 140 may store basic data for each unit, control data for the operational control of each unit, and input/output data. The memory 140 may store various data for the overall operation of the vehicle 100, such as programs for the processing or control of the controller 170. The memory 140 may be any of various hardware storage devices, such as a ROM, a RAM, an EPROM, a flash drive, and a hard drive.

The memory 140 may be integrally formed with the controller 170, or may be provided as an element of the controller 170.

The controller 170 may control overall operation of each unit in the vehicle 100. The controller 170 may include an ECU. The controller 170 may control the vehicle 100 based on information obtained through at least one of the object detection device 300 and the communication device 400. Accordingly, the vehicle 100 may perform autonomous driving under the control of the controller 170.

At least one processor and the controller 170 included in the vehicle 100 may be implemented using at least one selected from among Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, and electric units for the implementation of other functions.

The power supply unit 190 may receive power from a battery in the vehicle. The power supply unit 190 may supply power necessary for an operation of each component to components under the control of the controller 170.

The vehicle 100 may include an In-Vehicle Infotainment (IVI) system. The IVI system may operate in connection with the user interface device 200, the communication device 400, the controller 170, the navigation system 770, and the operation system 700. The IVI system reproduces multimedia contents in response to a user input and executes User Interfaces (UI) or User Experience (UX) program for various application programs.

The controller 170 may control V2X communication to transmit pedestrian information to another vehicle OB11 and to transmit walking guide information to the pedestrian terminal.

The controller 170 may further include an AI processor 800. AI may analyze a pedestrian image photographed by the camera 310 based on the learning result to determine a type of the pedestrian, and estimate a moving speed and an estimated road crossing time of the pedestrian.

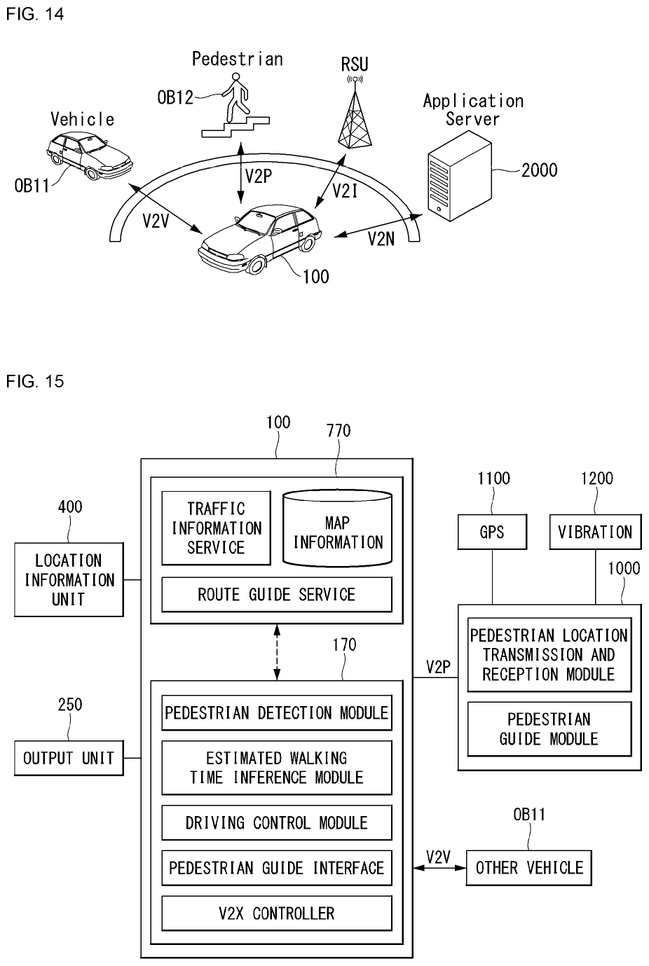

FIG. 14 is a diagram illustrating V2X communication.

Referring to FIG. 14, V2X communication includes communication between vehicle and all entities such as Vehicle-to-Vehicle (V2V) indicating communication between vehicles, Vehicle to Infrastructure (V2I) indicating communication between a vehicle and an eNB or a Road Side Unit (RSU), vehicle-to-pedestrian (V2P) indicating communication between a vehicle and a user equipment (UE) carried by an individual (pedestrian, bicyclist, vehicle driver, or passenger), and vehicle-to-network (V2N).

V2X communication may represent the same meaning as that of a V2X side link or NR V2X or may represent a more broad meaning including a V2X side link or NR V2X.

V2X communication may be applied to various services such as a forward collision warning, an automatic parking system, cooperative adaptive cruise control (CACC), a control loss warning, a traffic line warning, a traffic vulnerable person safety warning, an emergency vehicle warning, a speed warning upon driving a curved road, and traffic flow control.

V2X communication may be provided through a PC5 interface and/or a Uu interface. In this case, in a wireless communication system supporting V2X communication, a specific network entity for supporting communication between the vehicle and all entities may exist. For example, the network entity may be a BS (eNB), a road side unit (RSU), a UE, or an application server (e.g., traffic security server).

Further, a user terminal (UE) that performs V2X communication may mean a general handheld UE, a Vehicle UE (V-UE), a pedestrian UE, an eNB type RSU, a UE type RSU, or a robot having a communication module.

V2X communication may be directly performed between UEs or may be performed through the network object(s). According to an execution method of such V2X communication, a V2X operation mode may be classified.

In V2X communication, it is required to support privacy and pseudonymity of the UE when using a V2X application so that an operator or a third party may not track an UE identity in a region in which V2X is supported.

A term frequently used in V2X communication is defined as follows:
Road Side Unit (RSU): The RSU is a V2X serviceable device capable of transmitting/receiving to and from a moving vehicle using a V2I service. Further, the RSU is a fixed infrastructure entity that supports a V2X application and may exchange a message with another entity supporting a V2X application. The RSU is a term frequently used in an existing ITS specification, and the reason of introducing the term in a 3GPP specification is to enable to more easily read a document in an ITS industry. The RSU is a logical entity that couples V2X application logic to a function of the BS (referred to as a BS-type RSU) or the UE (referred to as a UE-type RSU).
V2I service: one type of the V2X service, one side thereof is a vehicle and the other side thereof is an entity belonging to an infrastructure.
V2P service: one type of the V2X service, one side thereof is a vehicle, and the other side thereof is a device (e.g., a mobile UE carried by a pedestrian, a bicyclist, a driver, or a passenger) carried by an individual.
V2X service: 3GPP communication service type in which a transmitting or receiving device is related to a vehicle.
V2X enabled UE: UE that supports a V2X service.
V2V service: a type of a V2X service, and both sides of communication are vehicles.
V2V communication range: direct communication range between two vehicles participating to the V2V service.

An V2X application referred to as Vehicle-to-Everything (V2X) has four types of (1) vehicle to vehicle (V2V), (2) vehicle to infrastructure (V2I), (3) vehicle to network (V2N), and (4) vehicle to pedestrian (V2P).

FIG. 42 illustrates a type of a V2X application.

The four types of V2X applications may use “co-operative awareness” that provides a more intelligent service for a final user. This means that entities such as vehicles 100 and OB11, an RSU, an application server 2000, and a pedestrian OB12 may correct knowledge (e.g., information received from adjacent other vehicle or sensor equipment) on a corresponding region environment so that the entities handle and share the corresponding knowledge in order to provide more intelligent information such as cooperative collision warning or autonomous driving.

According to the present invention, the vehicle 100 may generate pedestrian information using an AI processor thereof. Further, the vehicle 100 of the present invention is connected to an external device, for example, a server 2000 through V2N communication to receive pedestrian information obtained from an AI learning result of the server 200 and to send the pedestrian information to another vehicle OB11.

FIG. 15 is a diagram illustrating a pedestrian guidance system according to an embodiment of the present invention.

Referring to FIG. 15, the pedestrian guidance system includes a vehicle 100 that performs V2X communication.

A navigation system 770 of the vehicle 100 processes a real-time traffic information service, a map information service including map data, and a route guide service.

A controller 170 of the vehicle 100 may include an AI processor. The AI processor includes a pedestrian detection module for determining a pedestrian type to generate pedestrian information based on camera image analysis, an estimated walking time inference module for estimating an estimated road crossing time based on a pedestrian type, a pedestrian guide interface for generating pedestrian guide information, and a V2X controller for controlling V2X communication between the pedestrian OB11 and another vehicle OB11.

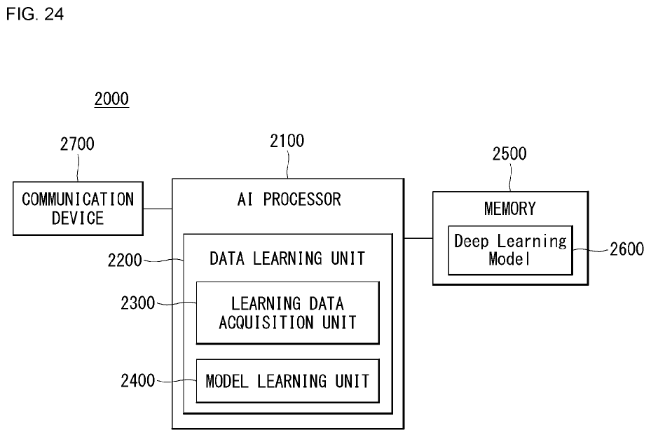

In another embodiment, the vehicle 100 may receive pedestrian information obtained by an AI learning result of the server 2000 through VTN communication. The server 2000 will be described in detail in an embodiment described with reference to FIG. 24.

A pedestrian terminal 1000 receives pedestrian guide information from the vehicle 100, the server 2000, or a pedestrian location transmitting and receiving module for transmitting a GPS signal from a location information unit 1100 to the vehicle 100 through V2P communication to output the pedestrian guide information to an output unit 1200. The output unit 1200 includes a display and a haptic output unit for outputting pedestrian guide information.

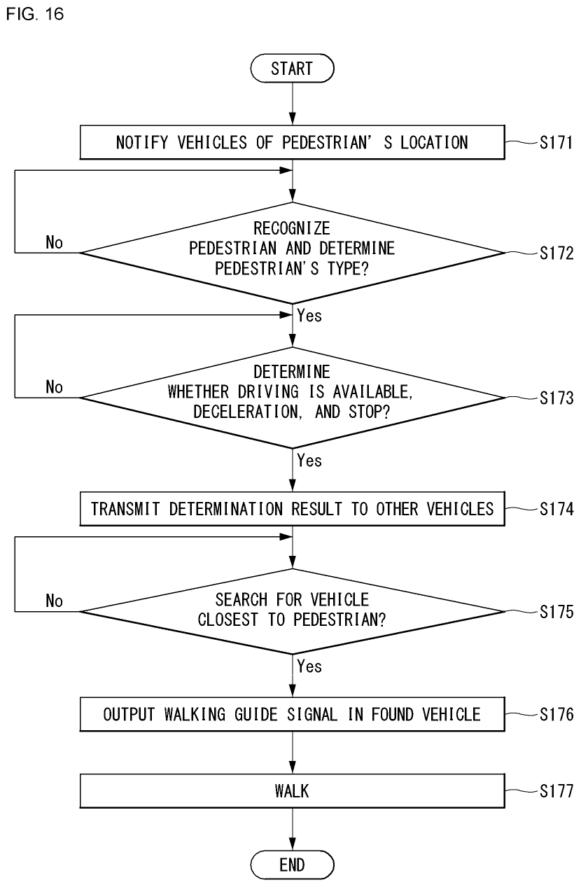

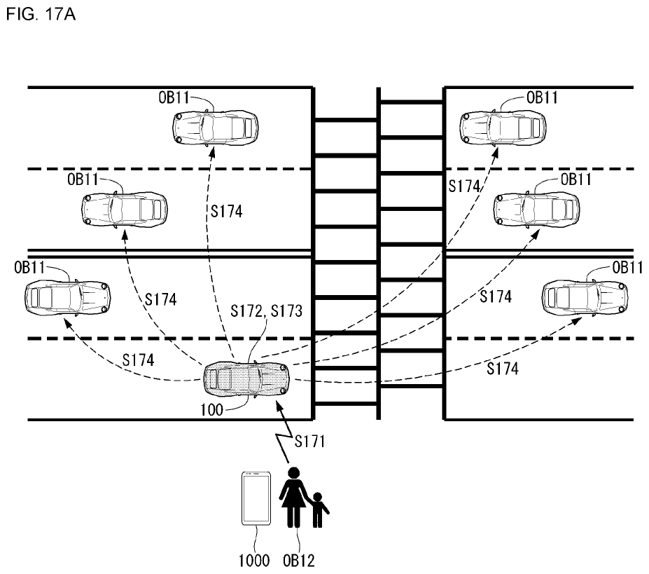

FIG. 16 is a flowchart illustrating step-by-step a control process of a walking guide method according to an embodiment of the present invention. FIGS. 17A and 17B are diagrams illustrating the walking guide method of FIG. 16.

Referring to FIGS. 16 to 17B, while the vehicles 100 and OB11 drive on a road, the pedestrian terminal 1000 transmits location information to the vehicles 100 and OB11 to notify peripheral vehicles 100 and OB11 of the pedestrian's location (S171). When a pedestrian stands around a crosswalk, location information, for example, a GPS signal from the pedestrian terminal 1000 may be transmitted to the vehicles 100 and OB11.

The vehicles 100 and OB11 recognize a pedestrian to analyze a pedestrian image obtained by camera photographing based on the AI learning result and to determine the pedestrian's type (S172). A vehicle, having first recognized the pedestrian OB12 or a vehicle closest to the pedestrian OB12 may determine a pedestrian type to transmit the determined result to peripheral vehicles.

After recognizing the pedestrian and capturing a pedestrian image, the vehicles 100 and OB11 may transmit the pedestrian image to the server 2000 through a network. The server 2000 may analyze the pedestrian image based on the AI learning result to determine a pedestrian type and transmit the pedestrian type to the vehicles 100 and OB11 approaching a road around the pedestrian.

The pedestrian type includes a pedestrian's age, sex, and status. The pedestrian status may be classified into a pedestrian with a load, a pedestrian accompanied by a baby carriage, a wheelchair, and a guide dog for a visually impaired person, or a fallen pedestrian. The pedestrian type may be used as an indicator for determining a walking vulnerable person such as infants, pregnant women, the disabled, and the elderly.

When receiving the pedestrian location and the pedestrian type, the vehicles 100 and OB11 determine whether driving is available, deceleration, and stop (S173).

When the controller 170 of the vehicles 100 and OB11 receives a pedestrian location and a pedestrian type while driving in a direction approaching the pedestrian, the controller 170 may control the brake drive unit 622 to decelerate a driving speed.

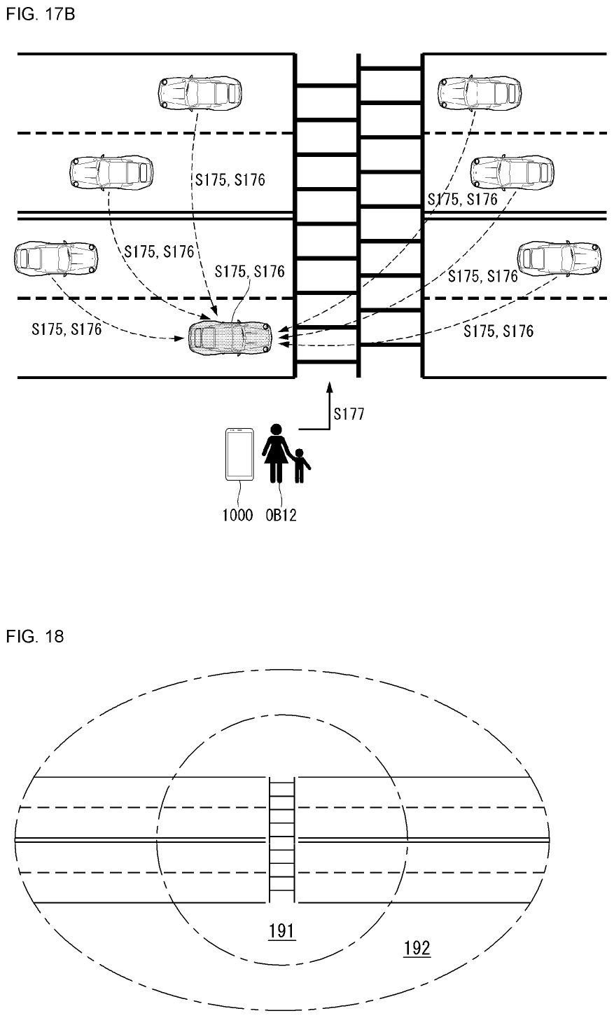

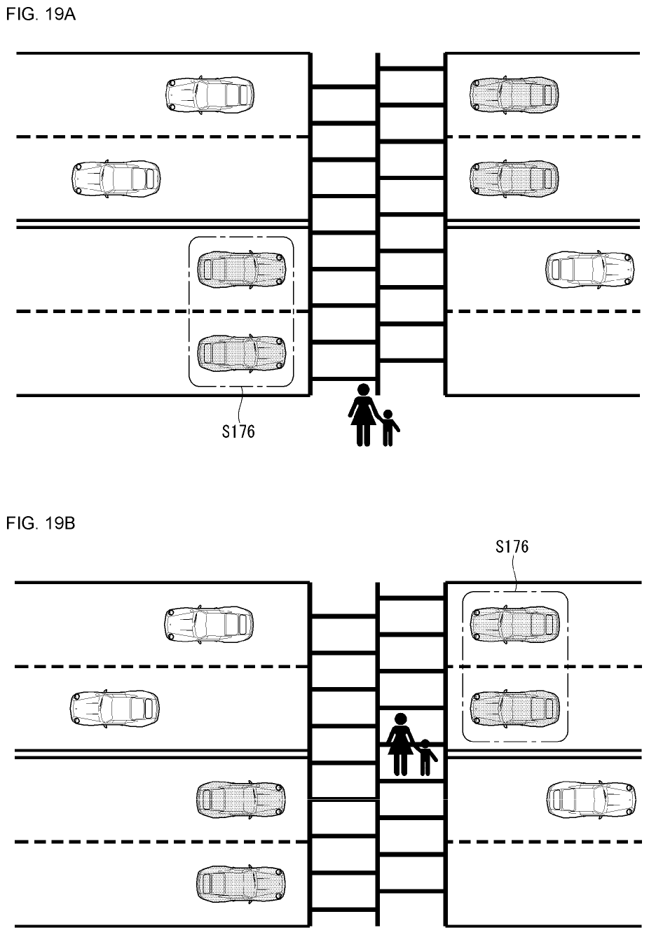

The controller 170 of the vehicles 100 and OB11 may adjust a braking force according to a distance to the pedestrian OB12. When the pedestrian location is within a predetermined distance, the controller 170 of the vehicles 100 and OB11 may lower a driving speed and stop the vehicles 100 and OB11 before the pedestrian OB12 starts to cross a crosswalk. For example, as illustrated in FIG. 18, a braking force of the vehicles 100 and OB11 in a first radial section 191 about the pedestrian OB12 may be controlled larger than that of the vehicles 100 and OB11 in a second radius section 192 larger than the first radius section 191.

When the pedestrian OB12 crosses a road, for safety of the pedestrian OB12, the vehicles 100 and OB11 transmit a determination result on whether driving is available, decelerate, and stop to other vehicles 100 and OB11 to request deceleration and stop to the peripheral vehicles (S174). When receiving the determination result from the other vehicles, the controller 170 of the vehicles 100 and OB11 transmits a response signal to the other vehicle and controls the brake drive unit 622 to lower a speed of the vehicles 100 and OB11. The response signal may include information on deceleration and whether to continue driving.

The controller 170 of the vehicles 100 and OB11 may determine a walking safety level when the pedestrian OB12 crosses a road based on the response signal of other vehicles.

The vehicles 100 and OB11 may search for the vehicles 100 and OB11 closest to the pedestrian OB12 through V2V communication (S175). When the pedestrian OB12 approaches or crosses the road, the vehicles 100 and OB11 closest to the pedestrian OB12 may output an advancing direction and an estimated crossing time of the pedestrian OB12 on the display based on an AI determination result (S176). Further, the vehicles 100 and OB11 may transmit walking guide information to the pedestrian terminal 1000. The pedestrian terminal 1000 may display a current location, whether road crossing is available, and an estimated crossing time on the display according to walking guide information and output such information as a vibration (haptic).

The estimated crossing time may be estimated based on the pedestrian's type and status. For example, in the case of the elderly and infants, the estimated crossing time may be set longer by +15 seconds than a predetermined reference time. Further, the estimated crossing time may be set to the sum of an existing traffic light time and an additional time according to the pedestrian type. When the pedestrian type is a walking vulnerable person, an estimated crossing time is added.

When pedestrians are several persons, an estimated crossing time may be calculated based on an estimated walking time of a slowest walking vulnerable person. The slowest walking vulnerable person may be set in advance based on the pedestrian's age and status. The infants, the elderly, the disabled, pregnant women, and pedestrians with heavy luggage or a companion may be set as a walking vulnerable person.

The estimated crossing time may be increased according to congestion of vehicles in a road around the pedestrian OB12. For example, when congestion of the vehicle is high, the estimated crossing time may increase by 5 seconds per lane. When congestion of the vehicle is low, the estimated crossing time may increase by 3 seconds per lane.

When recognition of the pedestrian type is unavailable, the pedestrian may be classified into other types. In the case of other types, an estimated crossing time may be set to a predetermined reference time.

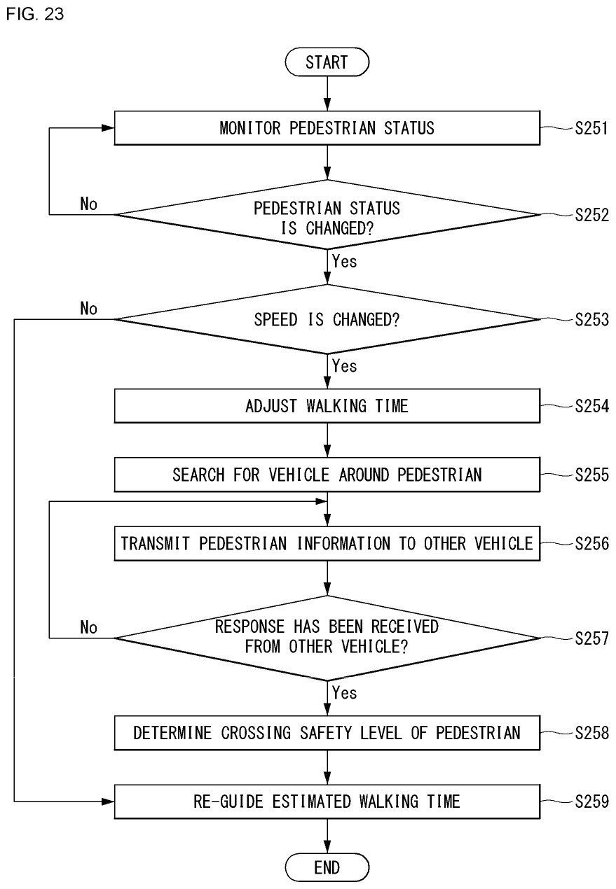

When the estimated crossing time is changed, the display of the vehicles 100 and OB11 and/or the pedestrian terminal 1000 may re-guide a changed estimated crossing time, as illustrated in FIG. 23.

The pedestrian OB12 may view walking guide displayed in the vehicles 100 and OB11 and a pedestrian guide message output from the pedestrian terminal 1000 and safely cross the road (S177).

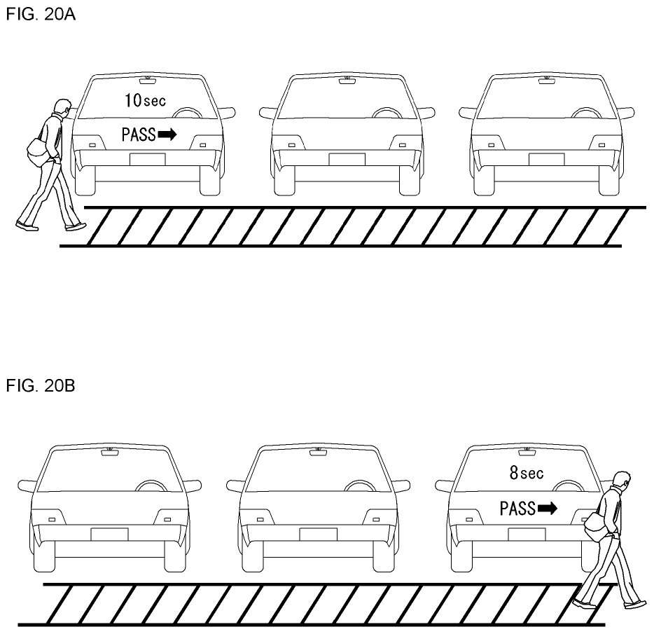

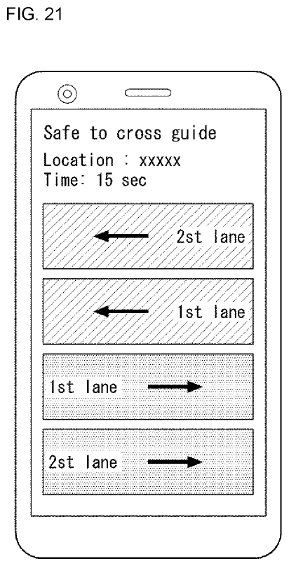

FIGS. 19a to 20b are diagrams illustrating an example in which a vehicle close to a pedestrian outputs walking guide information when the pedestrian crosses a road. FIG. 21 is a diagram illustrating an example of walking guide information output to a display of a pedestrian terminal.

When the pedestrian OB12 crosses a crosswalk of a road, the vehicle closest to the pedestrian OB12 may output walking guide information, as illustrated in FIG. 19a to FIG. 20b. The walking guide information may include at least one of crossing available guide, an estimated crossing remaining time, and a walking direction.

The pedestrian terminal 1000 may output walking guide information received from the vehicles 100 and OB12 or the server 2000 to a display and/or a vibration, as illustrated in FIG. 21. For example, when the pedestrian OB12 stands at an entry location of a crosswalk in a six-lane road, crossing available information and an estimated crossing time are displayed through the display of the vehicles 100 and OB11 in a third lane closest to the pedestrian OB12 and an estimated crossing time is counted according to a movement of the pedestrian OB12, as illustrated in FIG. 20A. When the pedestrian OB12 moves and passes through a first lane, crossing available information and an estimated crossing time may be displayed through the display of the vehicles 100 and OB11 in the first lane, as illustrated in FIG. 2OB. In this case, a display location of the walking guide information output to the display of the vehicles 100 and OB11 may be moved according to a movement of the pedestrian OB12.

When the pedestrian starts to cross a crosswalk, walking guide information of at least one of pedestrian available guide, an estimated crossing remaining time, and a walking direction may be output to a display of vehicles in two lanes closest to the pedestrian.

The estimated crossing time is short, walking guide information may be output through the terminal 1000 of the pedestrian. The controller 170 of the vehicles 100 and OB11 in a lane through which the pedestrian OB12 has passed may stop an output of walking guide information and control the operation system 700 to resume driving.

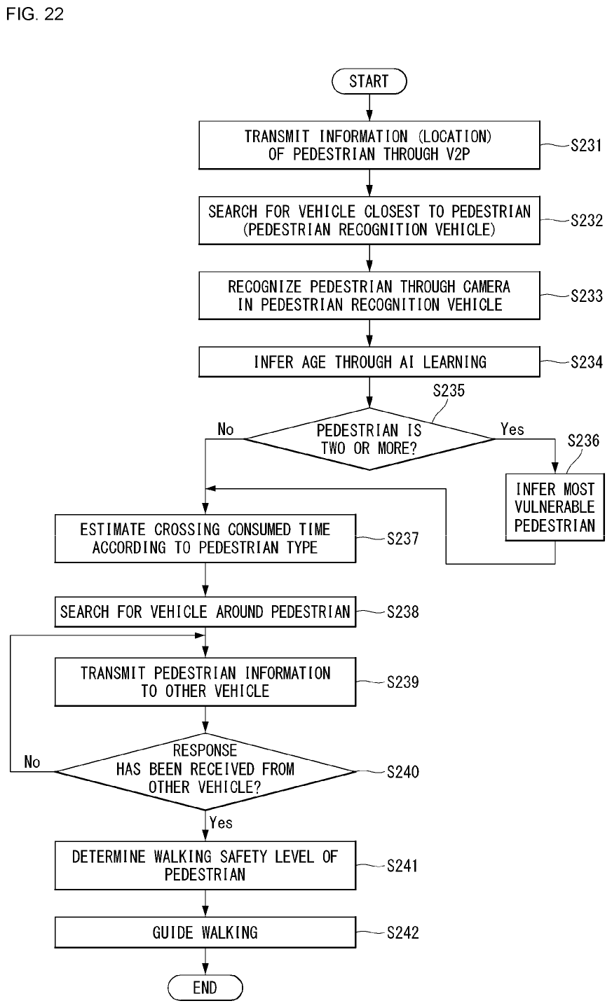

FIG. 22 is a flowchart illustrating in detail a pedestrian recognizing and determining method.

Referring to FIG. 22, the pedestrian terminal 1000 notifies peripheral vehicles of a location of the pedestrian OB12 through V2P communication (S231). The controller 170 of the vehicle, having recognized a pedestrian, for example, the vehicles 100 and OB11 closest to a pedestrian drives the camera 310 to photograph a pedestrian image. The vehicles 100 and OB11 may analyze a pedestrian image obtained from the camera based on an AI learning result to recognize a pedestrian and generate pedestrian information indicating the pedestrian and an estimated crossing time inference result of the pedestrian (S232, S233, and S234).

The pedestrian information may indicate a pedestrian type. The pedestrian type includes the pedestrian's age, sex, and status.

When the pedestrian is two or more, the controller 170 determines the most vulnerable pedestrian among pedestrians (S235 and S236). The most vulnerable pedestrian means a slowest walking vulnerable person and may be set in advance in consideration of the pedestrian's age and status.

The controller 170 or the server 2000 estimates an estimated crossing time according to the pedestrian type and searches for a vehicle closest to the pedestrian OB12 (S237 and S238). The controller 170 may transmit pedestrian information to the vehicle(s) close to the pedestrian OB12 (S239).

The controller 170 may determine a walking safety level when a pedestrian crosses a road based on a response signal received from other vehicle (S240 and S241). When a walking safety level is equal to or larger than a predetermine reference value, the controller 170 outputs walking guide information to the display and transmits the walking guide information to the pedestrian terminal 1000 to guide crossing of the pedestrian (S242).

FIG. 23 is a flowchart illustrating a walking guide method according to a pedestrian status change.

Referring to FIG. 23, the controller 170 of the vehicles 100 and OB11 analyzes a pedestrian image obtained from the camera to monitor in real time a pedestrian status (S251).

When it is determined that a moving speed of the pedestrian OB12 is changed with a change of a pedestrian status, the controller 170 adjusts the estimated crossing time (S254). The estimated crossing time may be varied in proportion to a moving speed of the pedestrian OB12.

The controller 170 or the server 2000 searches for a vehicle closest to the pedestrian OB12 (S255). The controller 170 may transmit pedestrian information to the vehicle(s) closest to the pedestrian OB12 (S256).

The controller 170 may determine a walking safety level when the pedestrian crosses a road based on a response signal received from other vehicle (S257). When a walking safety level is equal to or larger than a predetermined reference value, the controller 170 outputs walking guide information to the display and transmits the walking guide information to the pedestrian terminal 1000 to guide crossing of the pedestrian (S259).

FIG. 24 is a diagram illustrating an embodiment of determining a pedestrian type in the server 2000.

Referring to FIG. 24, the server 2000 includes an AI device. The AI device may include an AI processor 2100, a memory 2500 and/or a communication unit 2700.

The AI processor 2100 may learn a neural network using a program stored in the memory 2500. In particular, the AI processor 2100 may learn a neural network for recognizing vehicle related data and a pedestrian type.

The vehicle related data may include driver status information, vehicle driving information, vehicle status information, and navigation information and the like received from the vehicles 100 and OB11.

A neural network for recognizing vehicle related data and a pedestrian type may be designed to simulate a human brain structure on a computer and include a plurality of network nodes having a weight and simulating a neuron of the human neural network. The plurality of network modes may exchange data according to each connection relationship so as to simulate a synaptic activity of neurons that send and receive signals through a synapse.

The neural network may include a deep learning model developed in a neural network model. In the deep learning model, while a plurality of network nodes is located in different layers, the plurality of network nodes may send and receive data according to a convolution connection relationship. An example of the neural network model includes various deep learning techniques such as deep neural networks (DNN), convolutional deep neural networks (CNN), Recurrent Boltzmann Machine (RNN), Restricted Boltzmann Machine (RBM), deep belief networks (DBN), and a deep Q-network and may be applied to the field of computer vision, speech recognition, natural language processing, and voice/signal processing.

The AI processor 2100 for performing the above-described function may be a general-purpose processor (e.g., CPU), but may be an AI dedicated processor (e.g., GPU) for learning AI.

The memory 2500 may store various programs and data necessary for an operation of the AI device. The memory 2500 may be implemented into a non-volatile memory, a volatile memory, a flash memory, a hard disk drive (HDD), or a solid state drive (SDD) and the like. The memory 2500 may be accessed by the AI processor 21 and read/write/modify/delete/update of data may be performed by the AI processor 21. Further, the memory 250 may store a neural network model (e.g., deep learning model 26) generated through learning algorithm for data classification/recognition according to an embodiment of the present invention.

The AI processor 2100 may include a data learning unit 22 for learning a neural network for data classification/recognition. The data learning unit 2200 may learn learning data to use in order to determine data classification/recognition and a criterion for classifying and recognizing data using learning data. By obtaining learning data to be used for learning and applying the obtained learning data to a deep learning model, the data learning unit 2200 may learn a deep learning model.

The data learning unit 2200 may be produced in at least one hardware chip form to be mounted in the AI device. For example, the data learning unit 2200 may be produced in a dedicated hardware chip form for artificial intelligence (AI) and may be produced in a part of a general-purpose processor (CPU) or a graphic dedicated processor (GPU) to be mounted in the AI device. Further, the data learning unit 2200 may be implemented into a software module. When the data learning unit 2200 is implemented into a software module (or program module including an instruction), the software module may be stored in non-transitory computer readable media. In this case, at least one software module may be provided by an Operating System (OS) or may be provided by an application.

The data learning unit 2200 may include a learning data acquisition unit 2300 and a model learning unit 2400.

The learning data acquisition unit 2300 may obtain learning data necessary for a neural network model for classifying and recognizing data. For example, the learning data acquisition unit 2300 may obtain vehicle data and/or sample data for inputting as learning data to the neural network model.

The model learning unit 2400 may learn to have a determination criterion in which a neural network model classifies predetermined data using the obtained learning data. In this case, the model learning unit 2400 may learn a neural network model through supervised learning that uses at least a portion of the learning data as a determination criterion.

The model learning unit 2400 may learn the neural network model through unsupervised learning that finds a determination criterion by self-learning using learning data without supervision. Further, the model learning unit 2400 may learn the neural network model through reinforcement learning using feedback on whether a result of status determination according to learning is correct. Further, the model learning unit 2400 may learn the neural network model using learning algorithm including error back-propagation or gradient decent. When the neural network model is learned, the model learning unit 2400 may store a learned neural network model in the memory 2500.

In order to improve an analysis result of a recognition model or to save a resource or a time necessary for generation of the recognition model, the data learning unit 2200 may further include a learning data pre-processor (not illustrated) and a learning data selecting unit (not illustrated).

The learning data pre-processor may pre-process obtained data so that the obtained data may be used in learning for situation determination. For example, the learning data pre-processor may process the obtained data in a predetermined format so that the model learning unit 24 uses obtained learning data for learning for image recognition.

Further, the learning data selection unit may select data necessary for learning among learning data obtained from the learning data obtaining unit 2300 or learning data pre-processed in the pre-processor. The selected learning data may be provided to the model learning unit 2400. For example, by detecting a specific area of an image obtained through a camera of an intelligent electronic device, the learning data selection unit 2300 may select only data of an object included in the specified area as learning data.

Further, in order to improve an analysis result of the neural network model, the data learning unit 2200 may further include a model evaluation unit (not illustrated).

The model evaluation unit inputs evaluation data to the neural network model, and when an analysis result output from evaluation data does not satisfy predetermined criteria, the model evaluation unit may enable the model learning unit 22 to learn again. In this case, the evaluation data may be data previously defined for evaluating a recognition model. For example, when the number or a proportion of evaluation data having inaccurate analysis results exceeds a predetermined threshold value among analysis results of a learned recognition model of evaluation data, the model evaluation unit may evaluate evaluation data as data that do not satisfy predetermined criteria.

The communication unit 2700 may transmit an AI processing result by the AI processor 2100 to an external electronic device. The external electronic device may include an autonomous vehicle, a robot, a drone, an AR device, a mobile device, a home appliance and the like.

For example, when the external electronic device is an autonomous vehicle, the AI device 20 may be defined to another vehicle or a 5G network communicating with the autonomous module vehicle. The AI device 20 may be implemented with functionally embedded in the autonomous module provided in the vehicle. Further, the 5G network may include a server or a module for performing the autonomous driving related control.

The AI processor 2100 may estimate a pedestrian type and an estimated road crossing time of the pedestrian based on an analysis result of the pedestrian image using the data learning unit 2200.

It has been described that the AI device of the server 2000 of FIG. 24 is functionally divided into the AI processor 2100, the memory 2500, and the communication unit 2700, but the above-mentioned components may be integrated into a single module to be referred to as an AI module.

An autonomous vehicle of the present invention and a pedestrian guidance system and method using the same may be described as follows.

An autonomous vehicle according to the present invention includes a camera for photographing a pedestrian; a controller for recognizing a pedestrian location based on a signal received from a pedestrian terminal carried by the pedestrian and analyzing an image taken by the camera to determine a type of the pedestrian, and transmitting pedestrian information including the type of the pedestrian to other vehicle through a communication device; and a brake drive unit for decelerating a driving speed after recognition of the pedestrian under the control of the controller.

The controller determines the type of the pedestrian based on a learning result.

The type of the pedestrian includes at least one of the pedestrian's age, sex, and status.

The controller estimates an estimated road crossing time of the pedestrian based on the type of the pedestrian.

The controller transmits the estimated road crossing time of the pedestrian to other vehicles through the communication device.

The controller determines a safety level of the pedestrian according to whether to continue driving and deceleration information of a response signal received from the other vehicle.

The autonomous vehicle further includes a display for outputting walking guide information under the control of the controller. The walking guide information includes at least one of road crossing available guide of the pedestrian, an estimated crossing remaining time, and a walking direction.

The controller transmits the walking guide information to the pedestrian terminal through the communication device.

A pedestrian guidance system of the present invention includes a pedestrian terminal; and at least one autonomous vehicle for transmitting pedestrian information recognizing a pedestrian and indicating the pedestrian based on a signal received from the pedestrian terminal to other vehicle. The pedestrian information includes pedestrian type information obtained based on a pedestrian image taken by a camera. The pedestrian information is generated in a server for communicating with the vehicle through a controller of the vehicle or a network.

The controller or the server includes an artificial intelligence (AI) device for determining a type of the pedestrian based on a learning result.

The type of the pedestrian includes at least one of the pedestrian's age, sex, and status.

The controller or the server estimates an estimated road crossing time of the pedestrian based on the type of the pedestrian.

The controller uses the autonomous vehicle for transmitting the estimated road crossing time of the pedestrian to other vehicles through a communication device.

The controller determines a safety level of the pedestrian according to whether to continue driving and deceleration information of a response signal received from the other vehicle.

The vehicle further includes a display for outputting walking guide information under the control of the controller. The walking guide information includes at least one of road crossing available guide of the pedestrian, an estimated crossing remaining time, and a walking direction. The controller transmits the walking guide information to the pedestrian terminal through the communication device.

The controller or the server searches for a vehicle closest to the pedestrian. The vehicle closest to the pedestrian outputs walking guide information under the control of the controller. The walking guide information includes at least one of road crossing available guide of the pedestrian, an estimated crossing remaining time, and a walking direction.

A controller of a vehicle, having recognized the pedestrian analyzes the pedestrian image based on a learning result to determine a type of the pedestrian and to generate the pedestrian type information. The controller generates an estimated road crossing time of the pedestrian based on the pedestrian type. The controller transmits the pedestrian type information and the estimated crossing time to the other vehicle. The controller of the other vehicle receives the type of the pedestrian and information of the estimated crossing time to determine deceleration and whether to continue driving and to transmit a determined result to the vehicle, having recognized the pedestrian.

A method of guiding a pedestrian of the present invention includes recognizing a pedestrian based on a signal received from a pedestrian terminal; and transmitting pedestrian information indicating the pedestrian to other vehicle. The pedestrian information includes pedestrian type information obtained based on a pedestrian image taken by the camera. The pedestrian information is generated in a server for communicating with the vehicle through a network or a controller of the vehicle.

The pedestrian guide method further includes determining the pedestrian's type based on a learning result.

The type of the pedestrian includes at least one of the pedestrian's age, sex, and status.

The pedestrian guide method further includes estimating an estimated road crossing time of the pedestrian based on the pedestrian's type to transmit the estimated road crossing time to the other vehicle.

The pedestrian guide method further includes transmitting an estimated crossing time of the pedestrian to the other vehicle through a communication device.

The pedestrian guide method further includes determining a safety level of the pedestrian according to whether to continue driving and deceleration information of a response signal received from the other vehicle.

The pedestrian guide method further includes outputting walking guide information from at least one vehicle. The walking guide information includes at least one of road crossing available guide of the pedestrian, an estimated crossing remaining time, and a walking direction and is displayed in a display of the vehicle.

The pedestrian guide method further includes moving a display location of walking guide information displayed in the vehicles along a moving direction of the pedestrian.

The pedestrian guide method further includes transmitting the walking guide information to the pedestrian terminal through the communication device.

The pedestrian guide method further includes searching for a vehicle closest to the pedestrian; and outputting the walking guide information to a display of the vehicle closest to the pedestrian.

The present invention may be implemented as a computer readable code in a program recording medium. The computer readable medium includes all kinds of record devices that store data that may be read by a computer system. The computer may include a processor or a controller. The detailed description of the specification should not be construed as being limitative from all aspects, but should be construed as being illustrative. The scope of the present invention should be determined by reasonable analysis of the attached claims, and all changes within the equivalent range of the present invention are included in the scope of the present invention.

The features, structures, effects and the like described in the foregoing embodiments are included in at least an embodiment of the present invention and are not necessarily limited to an embodiment. Further, the features, structures, effects and the like illustrated in each embodiment can be combined and modified in other embodiments by those skilled in the art to which the embodiments belong. Therefore, it should be understood that contents related to such combinations and modifications are included in the scope of the present invention.

While the present invention has been described with reference to embodiments, the embodiments are only an illustration and do not limit the present invention, and it will be understood by those skilled in the art that various changes in form and details may be made therein without departing from the spirit and scope of the invention as defined by the appended claims. For example, each component specifically shown in the embodiments can be modified and implemented. It is to be understood that such variations and applications are to be construed as being included within the scope of the present invention as defined by the appended claims.

1. An autonomous vehicle, comprising:
a camera for photographing a pedestrian;
a controller for recognizing a pedestrian location based on a signal received from a pedestrian terminal carried by the pedestrian and analyzing an image taken by the camera to determine a type of the pedestrian, and transmitting pedestrian information comprising the type of the pedestrian to other vehicle through a communication device; and
a brake drive unit for decelerating a driving speed after recognition of the pedestrian under the control of the controller.

2. The autonomous vehicle of claim 1, wherein the controller determines the type of the pedestrian based on a learning result.

3. The autonomous vehicle of claim 1, wherein the type of the pedestrian comprises at least one of the pedestrian's age, sex, and status.

4. The autonomous vehicle of claim 1, wherein the controller estimates an estimated road crossing time of the pedestrian based on the type of the pedestrian.

5. The autonomous vehicle of claim 4, wherein the controller transmits the estimated road crossing time of the pedestrian to other vehicles through the communication device.

6. The autonomous vehicle of claim 1, wherein the controller determines a safety level of the pedestrian according to whether to continue driving and deceleration information of a response signal received from the other vehicle.

7. The autonomous vehicle of claim 1, further comprising a display for outputting walking guide information under the control of the controller,
wherein the walking guide information comprises at least one of road crossing available guide of the pedestrian, an estimated crossing remaining time, and a walking direction.

8. The autonomous vehicle of claim 7, wherein the controller transmits the walking guide information to the pedestrian terminal through the communication device.

9. A pedestrian guidance system using an autonomous vehicle, the pedestrian guidance system comprising:
a pedestrian terminal; and
at least one autonomous vehicle for transmitting pedestrian information recognizing a pedestrian and indicating the pedestrian based on a signal received from the pedestrian terminal to other vehicle,
wherein the pedestrian information comprises pedestrian type information obtained based on a pedestrian image taken by a camera, and
wherein the pedestrian information is generated in a server for communicating with the vehicle through a controller of the vehicle or a network.

10. The pedestrian guidance system of claim 9, wherein the controller or the server comprises an artificial intelligence (AI) device for determining a type of the pedestrian based on a learning result.

11. The pedestrian guidance system of claim 9, wherein the type of the pedestrian comprises at least one of the pedestrian's age, sex, and status.

12. The pedestrian guidance system of claim 9, wherein the controller or the server estimates an estimated road crossing time of the pedestrian based on the type of the pedestrian.

13. The pedestrian guidance system of claim 12, wherein the controller transmits the estimated road crossing time of the pedestrian to other vehicles through a communication device.

14. The pedestrian guidance system of claim 9, wherein the controller determines a safety level of the pedestrian according to whether to continue driving and deceleration information of a response signal received from the other vehicle.

15. The pedestrian guidance system of claim 9, wherein the vehicle further comprises a display for outputting walking guide information under the control of the controller,
wherein the walking guide information comprises at least one of road crossing available guide of the pedestrian, an estimated crossing remaining time, and a walking direction.

16. The pedestrian guidance system of claim 15, wherein the controller transmits the walking guide information to the pedestrian terminal through the communication device.

17. The pedestrian guidance system of claim 9, wherein the controller or the server is configured to:
search for a vehicle closest to the pedestrian; and
control the vehicle closest to the pedestrian to output walking guide information under the control of the controller,
wherein the walking guide information comprises at least one of road crossing available guide of the pedestrian, an estimated crossing remaining time, and a walking direction.

18. The pedestrian guidance system of claim 9, wherein a controller of a vehicle, having recognized the pedestrian is configured to:
analyze the pedestrian image based on a learning result to determine a type of the pedestrian and to generate the pedestrian type information;
generate an estimated road crossing time of the pedestrian based on the pedestrian type; and
transmit the pedestrian type information and the estimated crossing time to the other vehicle,
wherein a controller of the other vehicle receives the type of the pedestrian and information of the estimated crossing time to determine deceleration and whether to continue driving and to transmit a determined result to the vehicle, having recognized the pedestrian.

19. A method of guiding a pedestrian using an autonomous vehicle, the method comprising:
recognizing a pedestrian based on a signal received from a pedestrian terminal; and
transmitting pedestrian information indicating the pedestrian to other vehicle,
wherein the pedestrian information comprises pedestrian type information obtained based on an pedestrian image taken by the camera, and
wherein the pedestrian information is generated in a server for communicating with the vehicle through a network or a controller of the vehicle.

20. The method of claim 19, further comprising determining a type of the pedestrian based on a learning result.
